(19) United States
(12) Patent Application Publication
(10) Pub. No.: US 2019/0267855 A1
(43) Pub. Date: Aug. 29, 2019

(54) ROTARY ELECTRIC MACHINE

(71) Applicant: AISIN SEIKI KABUSHIKI KAISHA, Kariya-shi, Aichi-ken (JP)

(72) Inventors: Masafumi Sakuma, Chiryu-shi, Aichi-ken (JP); Teppei Tsuda, Nagoya-shi, Aichi-ken (JP)

(73) Assignee: AISIN SEIKI KABUSHIKI KAISHA, Kariya-shi, Aichi-ken (JP)

(21) Appl. No.: 16/343,545

(22) PCT Filed: Sep. 6, 2017
(86) PCT No.: PCT/JP2017/032144

§ 371 Date: Apr. 19, 2019

(30) Foreign Application Priority Data
Oct. 25, 2016 (JP) 2016-209108

(51) Int. Cl. H02K 1/16; H02K 1/27; H02K 21/14

(52) U.S. Cl. CPC H02K 1/165; H02K 29/03; H02K 21/14; H02K 1/278

(57) ABSTRACT

A rotary electric machine in which a moving direction of the mover relative to the stator as a first direction, an opposing direction in which the stator and the mover oppose to each other as a second direction and a direction perpendicular to any direction of the first direction and the second direction as a third direction are defined and one of the stator and the mover includes a first reference portion which is a reference to skew and a continuous skew portion arranged in the third direction by being gradually shifted in the first direction relative to the first reference portion. The maximum value of a skew amount of the continuous skew portion relative to the first reference portion is set to have the maximum value of the relative skew amount between the stator and the mover to be one slot pitch worth of the plurality of slots.

### TECHNICAL FIELD

This specification discloses a technology relating to a fraction slot structure rotary electric machine.

### BACKGROUND ART

As an invention associated with an integer slot structure rotary electric machine in which the number of slots per every pole and every phase is an integer value, the invention disclosed in Patent Literature 1 can be exampled. The reluctance motor according to the Patent Literature 1, it says “when the number of poles of the motor is designated as NRR, the center position of each magnetic pole of the rotor steel plate is shifted as much as slot pitch/NRR, 2×slot pitch/NRR, 3×slot pitch/NRR, . . . , one slot pitch in the rotor rotating direction for the position being equally divided into 360 degrees/NRR”. Moreover, the Literature 1 says “the stator and rotor of the reluctance motor are skewed relatively by the amount of slot pitch/NRR”. Therefore, the invention recited in the Patent Literature 1 can reduce the torque ripple, and accordingly, can reduce the vibrations derived from such torque ripple.

Further, the non-patent Literature 1 discloses that if the slot harmonic voltage has to be removed, normally the armature coil is skewed by the amount of one slot pitch and in the case of a fraction slot structure, the armature coil is skewed by the amount of one per c (1/c) slot pitch to obtain the same effect. It is noted here that the fraction slot structure is the slot structure in which the number of slots per every pole and every phase is not an integer value. Further, the character “c” above means the denominator portion when the number of slots per every pole and every phase is represented as mixed fraction and that the proper fraction portion of the mixed fraction is represented as irreducible fraction. It is also noted that the harmonic voltage corresponds to the torque ripple explained above.

### CITATION LIST

### Patent Literature

[Patent Literature 1] JP11(1999)-318062 A

[Non-Patent Literature] “PRACTICAL ELECTRIC MACHINE STUDY” written by Shoji Moriyasu and issued by Morikita Shuppan Co., Ltd, on Jul. 25, 2000 (first edition, first print, at page 72).

### SUMMARY OF INVENTION

### Technical Problem(s)

However, according to the invention described in the Patent Literature 1, an integer slot structure motor with a mover having six-magnetic poles and a stator having thirty-six (36) slots is the subject of the invention. According to the integer slot structure rotary electric machine, the opposing state of the magnetic poles between the stator magnetic pole and the mover magnetic pole becomes equal at every pole and accordingly, the distribution of the electromagnetic attractive force generated between the stator pole and the mover pole becomes approximately equal at every pole. Accordingly, issues of noise and vibration derived from the magnetic pole opposing state between the stator magnetic pole and the mover magnetic pole in the integer slot structure rotary electric machine occur less compared to those occurred at the fraction slot structure rotary electric machine. Therefore, like the invention recited in the Patent Literature 1, in many cases, the integer slot structure rotary electric machine may mainly focus on the improvement in reduction of the torque ripple and the countermeasures to the noise and vibration issues may be the ones which pertain to the reduction of torque ripple.

Further, according to the fraction slot structure rotary electric machine as disclosed in the non-Patent Literature 1, the torque ripple (including cogging of coil) can be reduced by skewing the slot by the amount of 1/c of the slot pitch. However, it is difficult to reduce the noise and the vibration of the rotary electric machine. In more concrete, according to the fraction slot structure rotary electric machine, the electromagnetic attractive force distribution generated between the stator pole and the mover pole becomes imbalanced in the equivalency of each pole and vibration force is generated with the order of space deformation mode obtained by dividing the number of magnetic poles of the mover by the value “c” defined above. In other words, according to the fraction slot structure rotary electric machine, compared to the integer slot structure rotary electric machine (“c”=1) which has the same number of magnetic poles of the mover, the fraction slot structure rotary electric machine generates a vibration force with the order lower than that of the integer slot structure rotary electric machine. The stator of the rotary electric machine has a specific number of vibrations corresponding to the space deformation mode and the lower the order of the space deformation mode, the lower the specific number of vibration drops. As a result, compared to the integer slot structure rotary electric machine (“c”=1) which has the same number of magnetic poles of the mover, at a lower number of rotations, the fraction slot structure rotary electric machine has a resonant point of the noise and the vibration where the specific number of vibrations corresponding to the space deformation mode of the stator and frequency of the lower order vibration force agree. Thus, a countermeasure has to be taken to this issue.

This specification discloses a fraction slot structure rotary electric machine which can reduce the noise and vibration and the torque ripple considering the above circumstances.

### Solution to Problem(s)

This specification discloses a fraction slot structure rotary electric machine which number of slots per every pole and every phase is not an integer value and the rotary electric machine includes a stator including a stator iron core provided with a plurality of slots and a plurality of stator coils inserted through the plurality of slots and a mover having a mover iron core and at least a pair of mover magnetic poles provided at the mover iron core. A moving direction of the mover relative to the stator is defined to be a first direction an opposing direction in which the stator and the mover oppose to each other is defined to be a second direction and a direction perpendicular to any one of the first direction and the second direction is defined to be a third direction. At least one of the stator and the mover includes a first reference portion which is a reference to skew and a continuous skew portion arranged in the third direction by being gradually shifted in the first direction relative to the first reference portion, wherein a maximum value of a skew amount of the continuous skew portion relative to the first reference portion is set such that a maximum value of a relative skew amount between the stator and the mover becomes one slot pitch worth of the plurality of slots.

### Advantageous Effect of Invention

According to the above rotary electric machine, at least one of the stator and the mover includes the first reference portion and the continuous skew portion. Further, the maximum skewing amount of the continuous skew portion relative to the first reference portion is set such that the maximum value of the relative skewing amount between the stator and the mover becomes the amount of one slot pitch worth of the plurality of slots. Accordingly, the rotary electric machine explained above can form a mixed distribution of the electromagnetic attractive force generated between the stator and the mover over in the entire third direction. Thus, the distribution of the attractive force can be averaged. As a result, the distribution of the attractive force at every pole can be averagely formed. Thus, the rotary electric machine explained above can equalize the distribution of the attractive force at every pole. Accordingly, the distribution of the attractive force can raise the order of the attractive force distribution to a higher order up to the same order of the integer slot structure rotary electric machine and further the number of rotations can be raised which agrees with the specific number of vibrations of the stator iron core to, for example, be able to set it even out of the range of driving number of rotations. In other words, the rotary electric machine explained above can reduce the noise and vibration by avoiding chances of resonance of the stator. Still further, at least one of the stator and the mover includes the continuous skew portion and therefore the torque ripple can be reduced in addition to the reduction of the noise and vibration of the rotary electric machine.

### BRIEF EXPLANATION OF DRAWINGS

FIG. 1 is a cut end surface view showing a part of the end surface of the rotary electric machine 10 cut in a plan vertical to a third direction (arrow Z direction) associated with a first embodiment;

FIG. 2 is a schematic view of an example of structure of the rotary electric machine 10 indicated in FIG. 1, showing a two-phase arrangement (one magnetic pole pair worth);

FIG. 3 is a schematic view of an example of magnetic pole opposing state between a plurality of teeth portions 21b and a pair of mover magnetic poles 32a, 32b associated with a reference embodiment;

FIG. 4 is a schematic view of an example of distribution of the electromagnetic attractive force in the second direction (arrow Y direction) acted on the plurality of teeth portions 21b associated with the reference embodiment;

FIG. 5A is a schematic view of an example of outer peripheral profile of the stator iron core 21;

FIG. 5B is a schematic view of another example of outer peripheral profile of the stator iron core 21;

FIG. 5C is a schematic view of further example of outer peripheral profile of the stator iron core 21;

FIG. 6A is a schematic view of an example of magnetic pole opposing state between a plurality of teeth portions 21b and a pair of mover magnetic poles 32a, 32b associated with the first embodiment;

FIG. 6B is a schematic view explaining the area of magnetic pole opposing state enclosed with a broken line of FIG. 6A;

FIG. 6C is a schematic view explaining the magnetic pole opposing state in case that the maximum value of skewing amount relative to the first reference portion 41 is not set by one slot pitch (1 sp) of the plurality of (60) slots 21c associated with the reference embodiment;

FIG. 7A is a schematic view of an example of the distribution of electromagnetic attractive force in the second direction (arrow Y direction) acted on the plurality of teeth portions 21b associated with the first embodiment;

FIG. 7B is a schematic view explaining mixing, averaging and equalization of the distribution of the attractive force at every separated portion;

FIG. 8A is a schematic view of one example of magnetic pole opposing state between the plurality of teeth portions 21b and the pair of mover magnetic poles 32a, 32b viewed from the third direction (arrow Z direction) associated with the first embodiment;

FIG. 8B is a schematic view of an example of skew state of the stator 20 associated with the first embodiment;

FIG. 8C is a schematic view of an example of skew state of the mover 30 associated with the first embodiment;

FIG. 9A is a schematic view of an example of skew state of the stator 20 associated with the second embodiment;

FIG. 9B is a schematic view of an example of skew state of the mover 30 associated with the second embodiment;

FIG. 10A is a schematic view of an example of skew state of the stator 20 associated with the third embodiment;

FIG. 10B is a schematic view of an example of skew state of the mover 30 associated with the third embodiment;

FIG. 11A is a schematic view of an example of skew state of the stator 20 associated with the first comparative embodiment;

FIG. 11B is a schematic view of an example of skew state of the mover 30 associated with the first comparative embodiment;

FIG. 12A is a schematic view of an example of skew state of the stator 20 associated with the second comparative embodiment;

FIG. 12B is a schematic view of an example of skew state of the mover 30 associated with the second comparative embodiment;

FIG. 13A is a schematic view of an example of skew state of the stator 20 associated with the fourth embodiment;

FIG. 13B is a schematic view of an example of skew state of the mover 30 associated with the fourth embodiment;

FIG. 13C is a schematic view of a converting method for converting the skew amount of the continuous skew portion 42 and the step skew portion 44;

FIG. 14A is a schematic view of an example of skew state of the stator 20 associated with the fifth embodiment;

FIG. 14B is a schematic view of an example of skew state of the mover 30 associated with the fifth embodiment;

FIG. 15 is a schematic view of an example of magnetic pole opposing state between a plurality of teeth portions 21b and two pairs of mover magnetic poles 32a, 32b associated with the reference embodiment;

FIG. 16A is a schematic view of an example of magnetic pole opposing state between a plurality of teeth portions 21b and two pairs of mover magnetic poles 32a, 32b associated with the sixth embodiment; and

FIG. 16B is a schematic view explaining the area of magnetic pole opposing state enclosed with a broken line of FIG. 16A.

### PREFERRED EMBODIMENTS IMPLEMENTED BY INVENTION

Embodiments of the invention will be explained hereinafter with reference to the attached drawings. The portions common to or similar to respective embodiments and modified embodiments are designated as the same numerals or symbols and overlapping explanations thereof are omitted. Further, the explanation made to one embodiment can be appropriately applicable to other embodiments or the modified embodiments. Further, it is noted that the drawings are conceptually illustrated, and sizes of portions and/or components of the detail structure are not precisely defined.

### First Embodiment

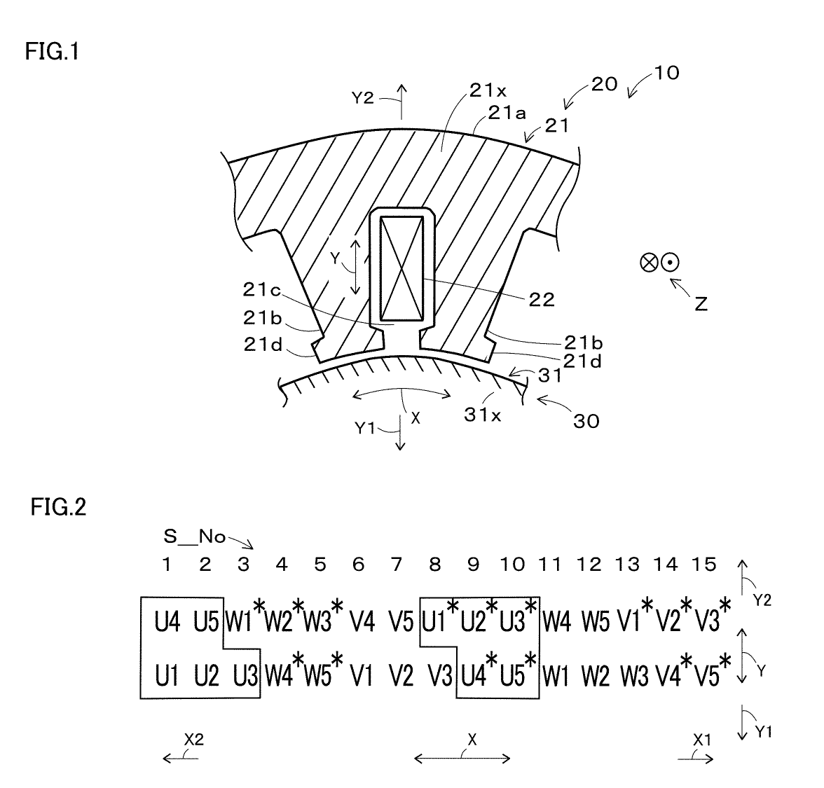

As shown in FIG. 1, the rotary electric machine 10 includes a stator 20 and a mover 30. The stator 20 includes a stator iron core 21 and a stator coil 22. The stator iron core 21 is provided with a plurality of slots 21c (in this embodiment, 60) and the stator coil 22 is inserted through the plurality of (60) slots 21c. It is noted that a three-phase stator coil is used for the stator coil 22.

The mover 30 is movably supported on the stator 20 and includes the mover iron core 31 and at least one pair of mover magnetic poles 32a, 32b (in this embodiment, four pairs of mover magnetic poles 32a, 32b) provided at the mover iron core 31. The rotary electric machine 10 of this embodiment is an eight (8) poles, sixty (60) slots structure rotary electric machine (basic structure thereof includes two (2) magnetic poles of the mover 30 and fifteen (15) slots of the stator 20). The number of slots at each pole and each phase is 2.5. In other words, the rotary electric machine 10 according to the embodiment is a fraction slot structure rotary electric machine which number of slots at each pole and each phase is not an integer value.

It is noted here that assuming that when the number of slots per every pole and every phase is represented by a mixed fraction, the integer part is defined as an integer portion “a”. Also, assuming that when the true fraction part of the mixed fraction is expressed by irreducible fraction, the numerator part is defined as numerator portion “b” and the denominator part is defined as denominator portion “c”. It is also noted here that the integer portion “a” is assumed to be zero or any positive integer and the numerator portion “b” and the denominator portion “c” are assumed to be any positive integer. Further, in the three-phase rotary electric machine 10, the value of denominator portion “c” is assumed to be two (2) or more, excluding the value of multiples of three (3). In the embodiment, the number of slots per every pole and every phase is 2.5 and the integer portion “a” is 2, the numerator portion “b” is 1 and the denominator portion “c” is 2. Further, in the specification of this application, the rotary electric machine 10 is expressed as a “b/c series” rotary electric machine, using the values of the numerator portion “b” and the denominator portion “c”. Accordingly, in this embodiment, the rotary electric machine 10 is expressed as the “½ series” rotary electric machine 10. It is noted here that in this specification, regardless of the value of the numerator portion “b”, if the value of denominator portion “c” is the same, related matters described in the specification can be applicable and accordingly, the b/c series rotary electric machines 10 are collectively referred to as “1/c series” rotary electric machine 10.

Further, the moving direction of the mover 30 relative to the stator 20 is defined as a first direction (arrow X direction). Further, the opposing direction of the stator 20 and the mover 30 is defined as a second direction (arrow Y direction). Still further, a direction from the stator 20 side to the mover 30 side in the second direction (arrow Y direction) is defined as the mover side second direction (arrow Y1 direction). Further, a direction from the mover 30 side to the stator 20 side in the second direction (arrow Y direction) is defined as the stator side second direction (arrow Y2 direction). Further, a direction perpendicular to any one of the first direction (arrow X direction) and the second direction (arrow Y direction) is defined as a third direction (arrow Z direction).

As shown in FIG. 1, the rotary electric machine 10 according to the embodiment is shown as a radial gap type cylindrical rotary electric machine, in which the stator 20 and the mover 30 are coaxially arranged. Therefore, the first direction (arrow X direction) corresponds to the circumferential direction of the rotary electric machine 10 and corresponds to the rotating direction of the mover 30 relative to the stator 20. Further, the second direction (arrow Y direction) corresponds to the radial direction of the rotary electric machine 10. Further, the third direction (arrow Z direction) corresponds to the axial direction of the rotary electric machine 10.

The stator iron core 21 is formed, for example, by laminating a plurality of electromagnetic steel plates 21x in the third direction (arrow Z direction). As a material of the electromagnetic steel plate 21x, for example, silicon steel plate can be used, and each of the plurality of electromagnetic steel plates 21x is formed in a thin plate shape. The stator iron core 21 includes a yoke portion 21a and a plurality (in this embodiment: 60) of teeth portions 21b integrally formed with the yoke portion 21a as a unit.

The yoke portion 21a is formed along in the first direction (arrow X direction). The plurality of (60) teeth portions 21b is formed so as to protrude from the yoke portion 21a in the mover side second direction (arrow Y1 direction). The plurality of slots 21c is formed by adjacently arranged teeth portions 21b , 21b in the first direction (arrow X direction), and the stator coils 22 are inserted through the plurality of (60) the slots 21c. Furthermore, each of the plurality (60) of teeth portions 21b has a tooth tip portion 21d. The tooth tip portion 21d is a distal end portion of the teeth portion 21b in the mover side second direction (arrow Y1 direction) and is formed such that the width thereof becomes wider towards the first direction (arrow X direction).

The conductor surface, for example, such as copper of the stator coil 22, is covered with an insulating layer such as an enamel. The cross-sectional shape of the stator coil 22 is not particularly limited to any shape and any desired cross-sectional shape may be applicable. For example, windings having various cross-sectional shapes, such as for example, a round wire having a circular cross section and a square wire having a polygonal cross section may be applicable. Also, parallel thin wires combined with a plurality of thinner wires may be applicable. If parallel fine wires are used, an excess current loss generated in the stator coil 22 can be reduced as compared with a single wire type and the efficiency of the rotary electric machine 10 can be improved. In addition, since the force required for wire winding molding can be reduced, the formability can be improved, and the manufacturing thereof can be facilitated.

Any stator coil 22 may be used, so far as such coil can be wound around the stator 20 of the fraction slot structure. The stator coil 22 can be wound, for example, by double layer winding, wave winding, concentric winding. Further, as shown in FIG. 2, the stator coil 22 can be formed in two layers in the second direction (arrow Y direction).

FIG. 2 shows an example of the phase arrangement of two magnetic poles (one magnetic pole pair) of the rotary electric machine 10 shown in FIG. 1. The rotary electric machine 10 of the embodiment is a three-phase machine, and the stator coil 22 includes a U phase (first phase) winding, a V phase (second phase) winding and a W phase (third phase) winding. The phases of the U-phase winding, the V-phase winding and the W-phase winding are shifted by 120° in electric angle. It is assumed that the phases of the U-phase winding, the V-phase winding and the W-phase winding are delayed in this order. Also, the U-phase winding includes a U1 phase winding, a U2 phase winding, a U3 phase winding, a U4 phase winding and a U5 phase winding. The U1 phase winding, the U2 phase winding and the U3 phase winding are shifted by one slot pitch in the first direction (arrow X direction). The U4 phase winding and the U5 phase winding are arranged so as to be shifted by one slot pitch in the first direction (arrow X direction). The U3 phase winding and the U4 phase winding are arranged to be shifted by a six (6) slot pitch in the first direction (arrow X direction). In this way, although the U1 phase winding, the U2 phase winding, the U3 phase winding, the U4 phase winding and the U5 phase winding are in the same phase (U phase), the arrangement on the stator 20 are different.

Further, in this figure, the energizing direction of the stator coil 22 is denoted with an asterisk. Specifically, in a phase (for example, U1*) with an asterisk, the energization direction of the stator coil 22 is reversed relative to a phase (for example, U1) without an asterisk. The same can be applied to the V phase winding and the W phase winding as described above. In the rotary electric machine 10 of this embodiment, the number of phase slots per every pole and every phase is 2.5. Therefore, the number of same phases adjacently arranged is repeated with two and three alternatively in the first direction (arrow X direction) at each layer.

As described above, in this embodiment, the stator coil 22 is wound in distributed winding. In the distributed winding, the winding pitch of the stator coil 22 is set to be larger than 1 slot pitch and is wound with approximately one magnetic pole width of the mover magnetic pole. In the distributed winding, the integer portion “a” of the number of slots per pole and per phase described above is one (1) or more positive integer (in this embodiment, the portion “a” is 2). In addition, the three-phase stator coil 22 is electrically connected by Y connection. It is noted that the stator coil 22 can also be wound in concentrated winding. In the concentrated winding, the winding pitch of the stator coil 22 is set to be equal to one slot pitch and is wound with one magnetic pole width of the stator magnetic pole. In concentrated winding, the integer portion “a” of the number of slots per every pole and every phase is 0 (zero). Further, the three-phase stator coil 22 can be electrically connected by triangle connection. It is noted however, the number of phases of the stator coil 22 is not limited.

For example, the mover iron core 31 is formed by laminating a plurality of electromagnetic steel plates 31x in the third direction (arrow Z direction). The plurality of electromagnetic steel plates 31x, for example, can be formed by a silicon steel plate and each of the plurality of electromagnetic steel plates 31x is formed in a thin plate shape. The rotary electric machine 10 of the embodiment is a cylindrical rotary electric machine, and the mover iron core 31 is formed in a cylindrical shape. In addition, the mover iron core 31 is provided with a plurality of magnet housing portions (not shown) along in the first direction (arrow X direction).

Permanent magnets (four pairs of mover magnetic poles 32a, 32b) of a predetermined number of magnetic poles (in this embodiment, four magnetic pole pairs) are housed in the plurality of magnet housing portions. The mover 30 is provided to be movable (rotatable) by the magnet and the rotating magnetic field generated at the stator 20. In this specification, a mover magnetic pole having one polarity (for example, N pole) of a pair of mover magnetic poles 32a and 32b is indicated by a mover magnetic pole 32a. A mover magnetic pole having the other polarity (for example, S pole) of the pair of mover magnetic poles 32a and 32b is indicated by a mover magnetic pole 32b.

As the permanent magnet, for example, a known ferrite system magnet or a rare earth system magnet can be used. It is noted that the manufacturing method of the permanent magnet is not limited. As the permanent magnet, for example, a resin bonded magnet or a sintered magnet can be used. For example, the resin bonded magnet is formed by casting ferrite-based raw material magnet powder with a resin, etc., and casting the same in the mover iron core 31 by injection molding or the like. The sintered magnet is formed, for example, by press-molding rare earth-based material magnet powders in the magnetic field and baking the same at high temperature. The mover 30 can be formed to have a surface magnet shape. According to the surface magnet shape mover 30, the permanent magnets are provided on the surface (outer surface) of the mover iron core 31 provided opposing to each tooth tip portion 21d of the stator iron core 21.

In this embodiment, the mover 30 is provided at the inner side of the stator 20 (the axial center side of the rotary electric machine 10) and is supported so as to be movable (rotatable) relative to the stator 20. Specifically, a shaft (not shown) is provided at the mover iron core 31 and the shaft penetrates through the axial center of the mover iron core 31 in the third direction (arrow Z direction). Both end portions of the shaft in the third direction (arrow Z direction) are rotatably supported by bearing members (not shown). As a result, the mover 30 is movable (rotatable) relative to the stator 20.

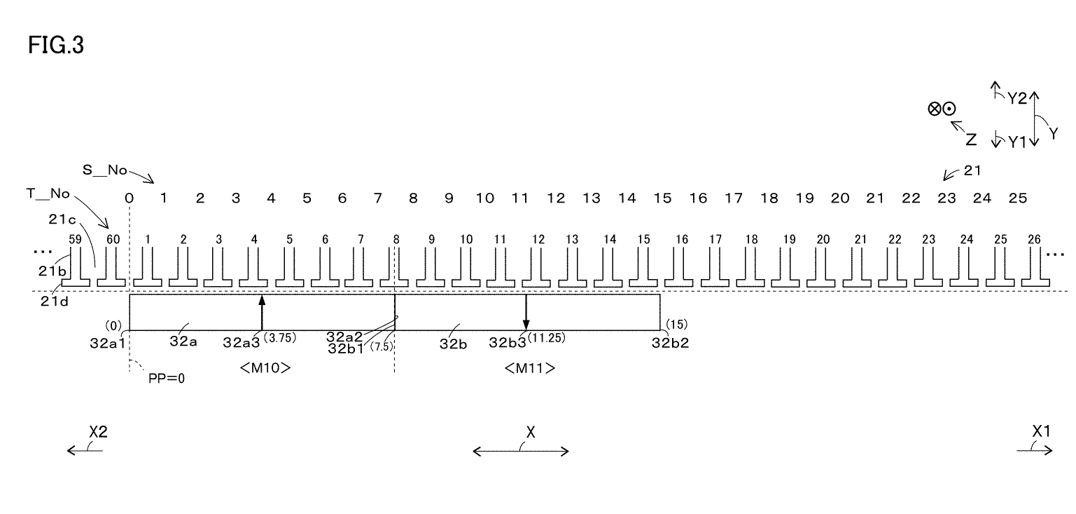

FIG. 3 shows an example of the magnetic pole opposing state between the plurality of teeth portions 21b and the pair of mover magnetic poles 32a, 32b according to the reference embodiment. In the figure, the annular stator iron core 21 is illustrated as linearly extended and the stator iron core 21 as viewed in the third direction (arrow Z direction) is shown. In the same figure, the yoke portion 21a and the stator coil 22 are omitted from the illustration and each teeth portion 21b is assigned with an identification number of a stator magnetic pole formed at the stator iron core 21 (hereinafter referred to as a stator magnetic pole number T_No.). In the present specification, for convenience of explanation, the center position of the slot 21 c (the slot number S_No is 0) between the stator magnetic pole number T_No being 60 and the stator magnetic pole number T_No being 1 is defined to be the positional reference (the position coordinate PP is 0) of the pair of mover magnetic poles 32a, 32b.

Also, in the same figure, a pair of mover magnetic poles 32a, 32b arranged in a circular arc shape is shown with a linearly extended state and as viewed in the third direction (arrow Z direction). In this figure, only the pair of mover magnetic poles 32a, 32b is shown and the other three pairs of the mover magnetic poles 32a, 32b are omitted. The arrows shown in the pair of mover magnetic poles 32a and 32b indicate the difference in polarity (N-pole and S-pole) of the above explained pair of mover magnetic poles 32a and 32b. The above-described method of illustration of FIG. 3 will be also applied for other figures, which will be used later on. However, there may appear otherwise specified figures, for example, two sets of the pair of mover magnetic poles 32a and 32b may be illustrated. Also, because of the illustration space for the drawings, each magnetic pole center position and each end position of the pair of mover magnetic poles 32a, 32b may be indicated only by numerical values in parentheses.

As shown in FIG. 3, one end portion 32a1 (position coordinate PP is 0) of both end portions 32a1, 32a2 in the first direction (arrow X direction) of the mover magnetic pole 32a is oppositely positioned to the center position of the slot 21c. On the other hand, the other end 32a2 (position coordinate PP is 7.5) of the both end portions 32a1, 32a2 of the mover magnetic pole 32a in the first direction (arrow X direction) is oppositely positioned to the center position of the teeth portion 21b. Therefore, the magnetic pole center position 32a3 (the position coordinate PP is 3.75) of the mover magnetic pole 32a is shifted in one direction (arrow X1 direction) of the first direction (arrow X direction) relative to the magnetic pole center position (the teeth portion 21b having the stator magnetic pole number T_No being 4).

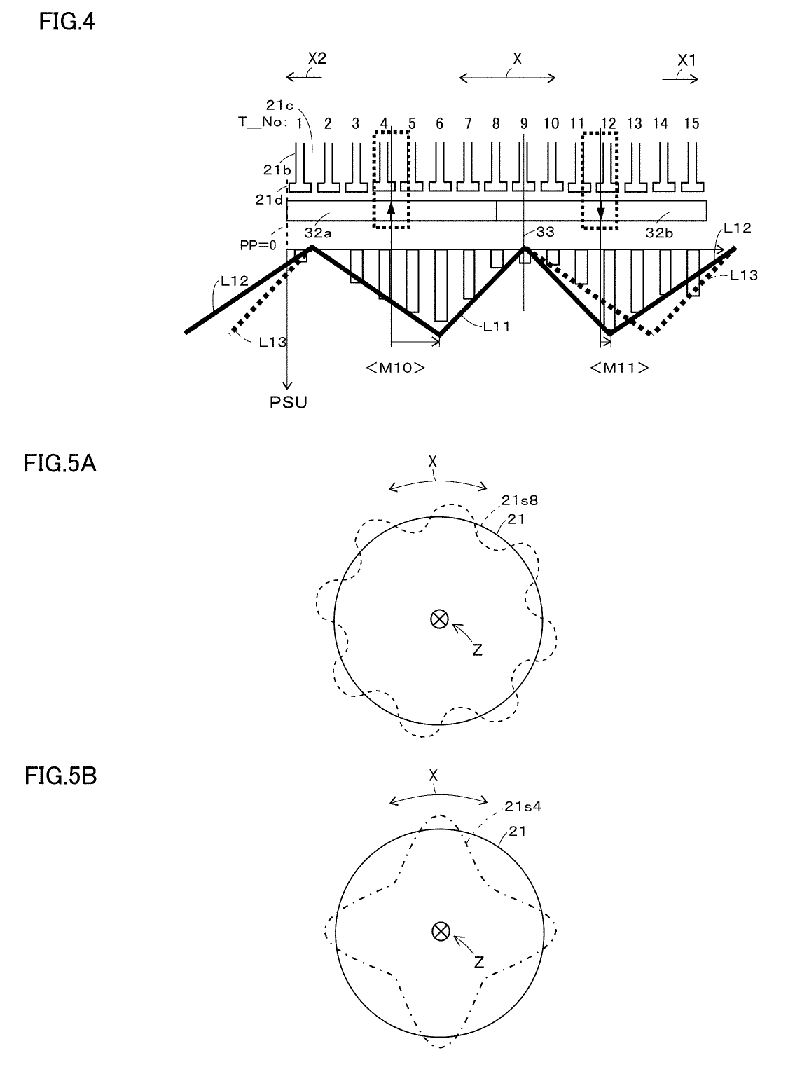

As a result, the electromagnetic attractive force distribution in the second direction (arrow Y direction) acting on the plurality of teeth portions 21b (hereinafter, also referred to as “attractive force distribution acting on the plurality of teeth portions 21b ” and may be simply referred to as “attractive force distribution”) is indicated by the distribution represented by the bar graph shown in FIG. 4. FIG. 4 shows an example of electromagnetic attractive force distribution in the second direction (arrow Y direction) acting on the plurality of teeth portions 21b according to the reference embodiment. The vertical axis shows the magnitude PSU of the attractive force and the horizontal axis shows the first direction (arrow X direction). The rotary electric machine according to the reference embodiment is different from the rotary electric machine 10 of the embodiment in that the mover 30 does not have a continuous skew portion 42 which will be explained later.

The attractive force distribution acting on the plurality of teeth portions 21b can be obtained by, for example, the magnetic field analysis. This analysis can be also applicable to the attractive force distribution of other embodiments which will be explained later. A solid line L11 indicates an approximate straight line approximating the attractive force distribution by a straight line per each stator magnetic pole represented by the bar graph. As shown in the figure, the peak value of the attractive force distribution of the mover magnetic pole 32a is shifted relative to the magnetic pole center position of the stator magnetic pole (the teeth portion 21b which stator magnetic pole number T_No is 4) in one direction (arrow X1 direction) of the first direction (arrow X direction). The magnetic pole opposing state where such attractive force distribution occurs is defined as the magnetic pole opposing state M10.

On the other hand, one end portion 32b1 (position coordinate PP is 7.5) of both end portions 32b1, 32b2 in the first direction (arrow X direction) of the mover magnetic pole 32b is oppositely positioned to the center position of the teeth portion 21b. On the other hand, the other end 32b2 (position coordinate PP is 15) of the both end portions 32b1, 32b2 of the mover magnetic pole 32b in the first direction (arrow X direction) is oppositely positioned to the center position of the slot 21c. Therefore, the magnetic pole center position 32b3 (the position coordinate PP is 11.25) of the mover magnetic pole 32b is shifted in the other direction (arrow X2 direction) of the first direction (arrow X direction) relative to the magnetic pole center position of the teeth portion 21b (the teeth portion 21b having the stator magnetic pole number T_No being 12).

As a result, the attractive force distribution acting on the plurality of teeth portions 21b becomes the distribution represented by the bar graph in FIG. 4. The solid line L12 shows an approximate straight line approximating the attractive force distribution by a straight line per each stator magnetic pole represented by the bar graph. As shown in the figure, the peak value of the attractive force distribution of the mover magnetic pole 32b is approximately within the magnetic pole center position of the stator magnetic pole (the teeth portion 21b having the stator magnetic pole number T_No being 12). The magnetic pole opposing state under which such attractive force distribution occurs is defined as the magnetic pole opposing state M11.

As described above, the ½ series rotary electric machine 10 has two kinds of magnetic pole opposing states M10 and M11, and has two kinds of attractive force distributions. Therefore, the pair of mover magnetic poles 32a and 32b located adjacently in the first direction (arrow X direction) has mutually a different attractive force distribution. As a result, the attractive force distribution acting on the plurality of teeth portions 21b is not equivalent per every magnetic pole, but is equivalent per every magnetic pole pair (per every two magnetic poles). This can be also said to not shown other pairs of movable magnetic poles 32a and 32b. In the ½ series rotary electric machine 10, a pair of mover magnetic poles 32a and 32b adjacently located with each other in the first direction (arrow X direction) having a mutually different attractive force distribution is moved in parallel in the first direction (arrow X direction) with a pair of mover magnetic poles as a unit to be able to achieve multiplication of the magnetic poles (in the embodiment, 8 multiple magnetic poles).

As shown in FIG. 4, two kinds of attractive force distributions (two kinds of magnetic pole opposing states M10 and M11) are approximately symmetrical (specular symmetry) relative to the mirror surface 33. The mirror surface 33 is defined to be a virtual reference surface formed by the second direction (arrow Y direction) and the third direction (arrow Z direction). For example, assuming that the mirror surface 33 formed at the center position of the teeth portion 21b having the stator magnetic pole number T_No of 9, the attractive force distributions (the magnetic pole opposing states M10 and M11) of the pair of mover magnetic poles 32a and 32b are approximately symmetrical (mirror symmetrical) relative to the mirror surface 33. Therefore, when the solid line L11 is folded back relative to the mirror surface 33, the line L11 approximately agrees to the solid line L12. This can be said for other pairs of mover magnetic poles 32a, 32b. The broken line L13 in FIG. 4 shows a state in which the solid line L11 is moved in parallel in the first direction (arrow X direction) by the distance of one magnetic pole of the mover 30. In addition, the area surrounded by the broken line in FIG. 4 shows the difference in the magnetic pole opposing state between the teeth portion 21b (stator magnetic pole) and the pair of mover magnetic poles 32a and 32b.

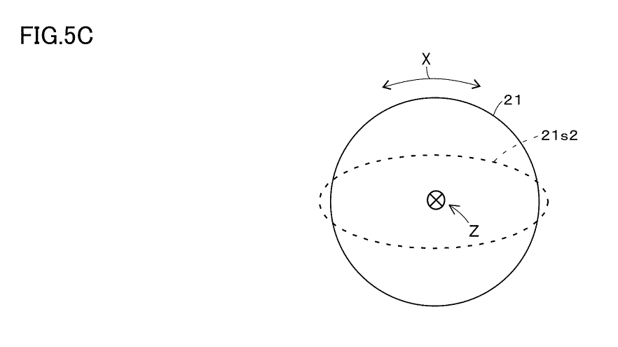

According to the two types of attractive force distributions (two types of magnetic pole opposing states M10 and M11), component of the lower order of vibration force (in this embodiment, the fourth order (space fourth order)) can be provided to the stator iron core 21, compared to the order (in this embodiment, eighth order (space eight order)) decided according to the number of magnetic poles of the mover 30 (in this embodiment, the number of magnetic poles is eight). As shown in FIGS. 5A to 5C, when the vibration force is acted on the stator iron core 21, the outer periphery of the stator iron core 21 is likely deformed into a shape shown by the broken line. FIGS. 5A to 5C show an example of the outer peripheral profile of the stator iron core 21 as viewed from the third direction (arrow Z direction). The outer peripheral profile of the stator iron core 21 before deformation is indicated by the solid line and the outer peripheral profile of the stator iron core 21 after deformation is indicated by the broken lines (curves 21s8, 21s4, and 21s2).

According to the rotary electric machine 10 (8-pole machine) having 8 magnetic poles of the mover 30, when the peak value of the attractive force is equivalent to each pole (for example, rotary electric machine with 8 pole, 24 slot structure, or 8 pole, 48 slot structure), strong and weak vibration forces are alternatively repeated eight times per one turn of the stator iron core 21. As a result, the outer peripheral profile of the stator iron core 21 tends to be deformed for example, as shown by the curve line 21s8 in FIG. 5A. As explained, the integer slot structure eight-pole rotary electric machine 10 has the component of the vibration force of eighth order (space eighth order). The eighth order (space eighth order) vibration force is decided depending on the number of magnetic poles (in this case, eight poles) of the mover 30 and is repeatedly given per one magnetic pole as a unit.

On the other hand, when the peak value of the attractive force does not become equivalent per each pole but becomes equivalent at every other pole per one magnetic pole pair (per every two magnetic poles) (for example, rotary electric machine with 8 pole, 36 slot structure, or 8 pole, 60 slot structure, etc.), strong and weak vibration forces are alternatively repeated four times per one turn of the stator iron core 21. As a result, the outer peripheral profile of the stator iron core 21 tends to be deformed for example, as shown by the curve line 21s4 in FIG. 5B. As explained, the eight-pole rotary electric machine 10 having the fraction slot structure (½ series) has the component of the vibration force of fourth order (space fourth order).

Further, when the peak value of the attractive force does not become equivalent per each magnetic pole and per every magnetic pole pair but becomes equivalent per every two magnetic pole pairs (per every four magnetic poles) (for example, rotary electric machine with 8 pole, 30 slot structure, or 8 pole, 54 slot structure, etc.), the strong and weak vibration forces are repeated twice per one turn of the stator iron core 21. As a result, the outer peripheral profile of the stator iron core 21 tends to be deformed as shown by the curve line 21s2 in FIG. 5C. As explained, the eight-pole rotary electric machine 10 having the fraction slot structure (¼ series) has the component of the vibration force of second order (space second order).

As described above, in the fraction slot structure rotary electric machine 10, the component of the lower order vibration force can be provided (in this embodiment, the fourth order (space fourth order)) to the stator iron core 21, compared to the order (in this embodiment, eighth order (space eight order)) decided according to the number of magnetic poles of the mover 30 (in this embodiment, the number of magnetic poles is eight). Therefore, in the rotary electric machine 10 with a wide range of driving number of rotations, the number of rotations that is equal to the number of specific vibrations of the stator iron core 21 is likely to occur within the driving number of rotations. As a result, resonance of the stator 20 occurs, and the noise and vibration of the rotary electric machine 10 may increase. Therefore, the rotary electric machine 10 of this embodiment can raise the order of the attractive force distribution to the same order level (eighth order (space eight order) in this embodiment) with that of the integer slot structure rotary electric machine.

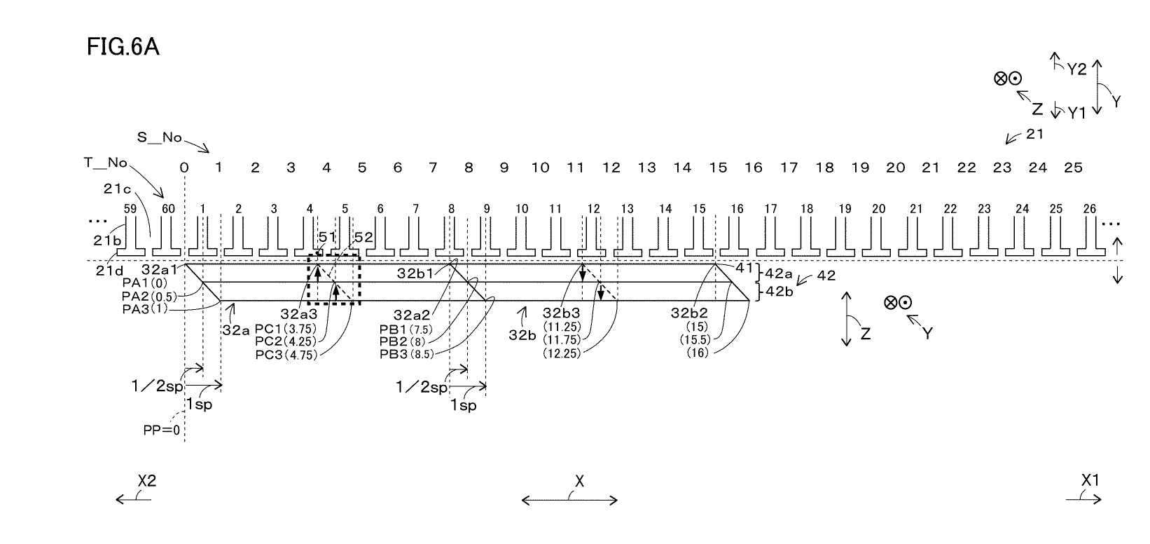

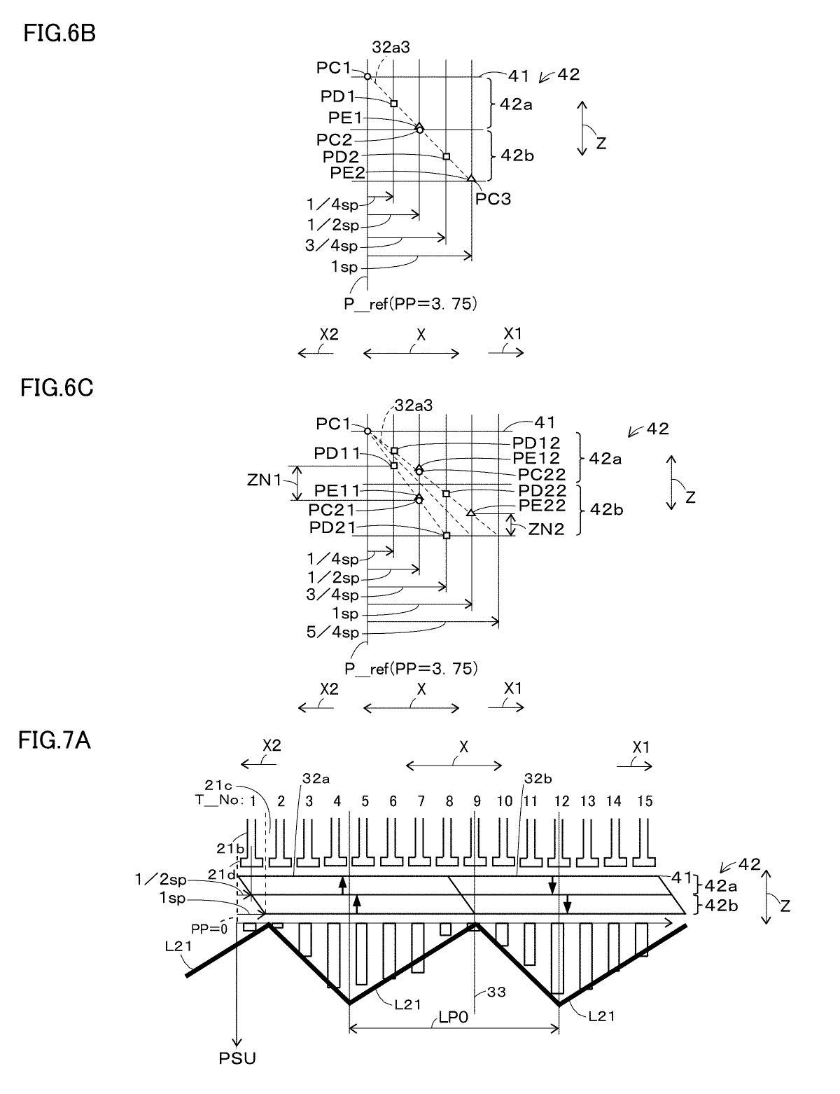

FIG. 6A shows an example of the magnetic pole opposing state between the plurality of teeth portions 21b and the pair of mover magnetic poles 32a, 32b according to this embodiment. For convenience of explanation, the figure (FIG. 6A) is partially different from the illustrating method shown in FIG. 3. Specifically, the stator 20 has a plurality of teeth portions 21b (a plurality of stator magnetic poles) in the third direction (arrow Z direction) and a plurality of slots 21c, which are similar to those illustrated in FIG. 3. On the other hand, the mover 30 is shown in the figure such that the second direction (arrow Y direction) of the stator 20 and the third direction (arrow Z direction) of the mover 30 agree on the same plane. The illustration method in the figure is switched over bordering the gap between the stator 20 and the mover 30. As explained, in the figure, the stator 20 as viewed from the third direction (arrow Z direction) and the mover 30 as viewed from the second direction (arrow Y direction) are both illustrated. This illustration is made for the convenience purpose in order to clearly show the positional relationship between the continuous skew applied to the mover 30 and the first direction (arrow X direction) of the stator 20, and the illustration method is different from that of FIG. 3.

As shown in the figure, in this embodiment, the mover 30 includes a first reference portion 41 and a continuous skew portion 42. The first reference portion 41 is a portion which becomes the reference portion to skew. The continuous skew portion 42 is a portion gradually shifted in the first direction (arrow X direction) relative to the first reference portion 41 and is arranged in the third direction (arrow Z direction). In this embodiment, the continuous skew portion 42 is gradually shifted relative to the first reference portion 41 in one direction (arrow X1 direction) of the first direction (arrow X direction) and is arranged in the third direction (arrow Z direction).

It is noted here that the figure illustrates the first reference portion 41 and the continuous skew portion 42 using a pair of mover magnetic poles 32a, 32b, as an example, but the same illustration can be applicable to the mover iron core 31. In other words, the plurality of electromagnetic steel plates 31x (continuous skew portions 42) forming the mover iron core 31 is shifted gradually relative to one electromagnetic steel plate 31x (first reference portion 41) forming the mover iron core 31 in one direction (arrow X1 direction) of the first direction (arrow X direction) and is arranged (layered) in the third direction (arrow Z direction).

Further, when the continuous skew portion 42 is bisected along the first direction (arrow X direction) on a plane perpendicular to the third direction (arrow Z direction), each portion is referred to as a first continuous skew portion 42a and a second continuous skew portion 42b in order from the first reference portion 41 side. As described above, for convenience of explanation, in the figure, the continuous skew portion 42 is divided into the first continuous skew portion 42a and the second continuous skew portion 42b, but the continuous skew portion 42 is formed integrally as a unit. In this figure, the first reference portion 41 is one end side end surface of the pair of mover magnetic poles 32a, 32b in the third direction (arrow Z direction). Further, one end surface at a side different from the border surface between the first continuous skew portion 42a and the second continuous skew portion 42b of the both end surfaces of the second continuous skew portion 42b in the third direction (arrow Z direction) is the other end side end surface of the pair of mover magnetic poles 32a, 32b in the third direction (arrow Z direction).

In the continuous skew portion 42, the maximum value of the skew amount relative to the reference portion 41 is set so that the maximum value of the relative skew amount between the stator 20 and the mover 30 becomes equal to one slot pitch (1 sp) worth of the plurality of slots 21c (60 in this embodiment). In this embodiment, the mover 30 includes the first reference portion 41 and the continuous skew portion 42, but the stator 20 does not have the first reference portion 41 and the continuous skew portion 42. Accordingly, the skew amount of the stator 20 is 0 and the maximum value of the skew amount of the continuous skew portion 42 of the mover 30 relative to the first reference portion 41 is set to be 1 slot pitch (1 sp) worth.

More specifically, as shown in FIG. 6A, the pair of mover magnetic poles 32a, 32b on the boundary surface between the first continuous skew portion 42a and the second continuous skew portion 42b is shifted by ½ slot pitch (½ sp) in one direction (arrow X1 direction) of the first direction (arrow X direction) relative to the first reference portion 41. Further, the other end side end surface of the pair of mover magnetic poles 32a, 32b in the third direction (arrow Z direction) is shifted by one slot pitch (1 sp) in the one direction (arrow X1 direction) of the first direction (arrow X direction) relative to the first reference portion 41. It is noted here that the rotary electric machine 10 of this embodiment is a rotary electric machine having an 8-pole and 60-slot structure (a rotary electric machine whose basic structure is that the number of magnetic poles of the mover 30 is 2 and the number of slots of the stator 20 is 15). One slot pitch (1 sp) corresponds to an electric angle of 24° (=360°/15 slots).

One end portions 32a1 (the position coordinate PP is 0, which is indicated by a position PA1) of both end portions 32a1, 32a2 of the mover magnetic pole 32a of the first reference portion 41 in the first direction (arrow X direction) is oppositely positioned to the center position of the slot 21c. The other end portions 32a2 (the position coordinate PP is 7.5, which is indicated by a position PB1) of both end portions 32a1, 32a2 of the mover magnetic pole 32a of the first reference portion 41 in the first direction (arrow X direction) is oppositely positioned to the center position of the teeth portion 21b. Under such situation, the magnetic pole center position 32a3 of the mover magnetic pole 32a of the first reference portion 41 (the position coordinate PP is 3.75 and is indicated by the position PC1) is arranged being shifted in one direction (arrow X1 direction) of the first direction (arrow X direction) relative to the magnetic pole center position (the teeth portion 21b with the stator magnetic pole number T_No of 4).

One end portions 32a1 (the position coordinate PP is 0.5, which is indicated by a position PA2) of both end portions 32a1, 32a2 of the mover magnetic pole 32a of the continuous skew portion 42a and the second continuous skew portion 42b in the first direction (arrow X direction) Is oppositely positioned to the center position of the teeth portion 21b. The other end portions 32a2 (the position coordinate PP is 8, which is indicated by a position PB2) of both end portions 32a1, 32a2 of the mover magnetic pole 32a in the first direction (arrow X direction) Is oppositely positioned to the center position of the slot 21c. Under such situation, the magnetic pole center position 32a3 of the mover magnetic pole 32a (the position coordinate PP is 4.25 and is indicated by the position PC2) is arranged being shifted in the other direction (arrow X2 direction) of the first direction (arrow X direction) relative to the magnetic pole center position of the teeth portion 21b (the teeth portion 21b with the stator magnetic pole number T_No of 5).

The attractive force distribution formed at the position PC 1 (position coordinate PP is 3.75) and the attractive force distribution formed at the position PC 2 (position coordinate PP 4.25) are mixed, and are averaged. As a result, it is possible to equalize the attractive force distribution per each pole and the component of the vibration force of the eighth space order increases. In other words, in comparison with the order decided based on the number of magnetic poles of the mover 30 (eight poles in this embodiment) (the eighth order (space eighth order) in this embodiment), the lower order (fourth order (space fourth order) in this embodiment) component of the vibration force is spatially overlapped with a half wavelength being shifted, and the order of these attractive force distributions is raised to the order level of an integer slot structure rotary electric machine (in this embodiment, eight order (space eight order)).

In this specification, a portion separated from a 1/c slot pitch (in this embodiment, ½ slots pitch (½ sp)) represented by using denominator portion “c” of the number of slots per every pole, every phase, in the first direction (arrow X direction) is referred to as a separated portion. The portion between the position indicated by the position PC1 (the positional coordinate PP is 3.75) and the position indicated by the position PC2 (the position coordinate PP is 4.25) is a separated portion. Similar to the above explanation, relative to the separated portion between the positions indicated by position PC1 (position coordinate PP is 3.75) and PC2 (position coordinate PP is 4.25), the same can be said to this situation.

FIG. 6B is a schematic view for explaining the magnetic pole opposing state of the area surrounded by the broken line in FIG. 6A. The circle marks in the figure represent a separated portion between the position PC1 (position coordinate PP is 3.75) and the position PC2 (position coordinate PP is 4.25). The square marks represent a separated portion between the position PD1 (position coordinate PP is 4) and position PD2 (position coordinate PP is 4.5). The triangle marks represent a separated portion between the position PE1 (position coordinate PP is 4.25) and position PE2 (position coordinate PP is 4.75). As shown in the same figure, these separated portions are positioned on the broken line indicating the magnetic pole center position 32a3 of the mover magnetic pole 32a. In any of the separated portions, the same can be said to the separated portions relative to the position PC1 (position coordinate PP is 3.75) and the position PC2 (position coordinate PP is 4.25).

The above can be also said to the separated portions other than the portions illustrated in the figure (separated portions on the broken line which indicates the magnetic pole center position 32a3). In other words, the same relationship explained above, (i.e., the separated positional relationship separated in the first direction (arrow X direction) by ½ slot pitch (½ sp)) can be established over the entire area of the mover 30 in the third direction (arrow Z direction). Further, the magnetic pole opposing state shown in the figure repeatedly occurs in the first direction (arrow X direction) by one slot pitch (1 sp) of the plurality (60) of slots 21c as a unit accompanied by the movement of the mover 30 (movement of the magnetic pole center position 32a3 of the mover magnetic pole 32a by one slot pitch (1 sp) of the plurality of (60) slots 21c).

As stated above, by setting the maximum value of the skew amount relative to the first reference portion 41 to the one slot pitch (1 sp) worth of the plurality (60) of the slots 21c, the attractive force distribution can be mixed and averaged over the entire third direction (arrow Z direction) of the mover 30. As a result, equalization of the attractive force distribution per each pole can be achieved to thereby increase the component of space eight order vibration force. More specifically, relative to the separated portions (in the example shown in FIG. 6B, for example, the separated portions between the circle, square and triangle marks), compared to the order (in the embodiment, the eighth order (space eighth order)) decided depending on the number of magnetic poles of the mover 30 (in the embodiment, eight poles), the component of lower order vibration force (in the embodiment, the fourth order (space fourth order)) spatially overlapped with half wavelength shifted and the attractive force distribution can be raised to the order level of integer slot structure rotary electric machine (in the embodiment, the eighth order (space eighth order)) can be obtained.

It is noted here that in the case where the maximum value of the skew amount relative to the first reference portion 41 is not set by one slot pitch (1 sp) worth of the plurality of (60) slots 21c, there remains an area where the relationship (the separated positional relationship separated in the first direction (arrow X direction) by ½ slot pitch (½ sp)) cannot be established. As a result, the component of the lower order vibration force (in this embodiment, the fourth order (space fourth order)) remains in the area and it is difficult to achieve mixing, averaging and equalization of the attractive force distribution of the mover 30 over the entire third direction (arrow Z direction).

FIG. 6C is a view schematically illustrating and explaining the magnetic pole opposing state in the case where the maximum value of the skew amount relative to the first reference portion 41 is not set to the one slot pitch (1 sp) worth of the plurality of (60) slots 21c according to the reference embodiment. The figure shows the arrangement of each separated portion shown in FIG. 6B relative to the first case and the second case. FIG. 6 is a diagram illustrating the arrangement of the respective separated portions shown in FIG. 6B for the first case and the second case. In the first case, the maximum value of the skew amount relative to the first reference portion 41 is set to the ¾ slot pitch (¾ sp) worth of the plurality of (60) slots 21c, whereas in the second case, the maximum value of the skew amount relative to the first reference portion 41 is set to the 5/4 slot pitch ( 5/4 sp) worth of the plurality of (60) slots 21c.

The separated portion between the position PC1 (the position coordinate PP is 3.75) and the position PC2 (the position coordinate PP is 4.25) in FIG. 6B corresponds to the separated portion between the position PC1 (the position coordinate PP is 3.75) and the position PC21 (position coordinate PP is 4.25) in the first case shown in FIG. 6C. These separated portions are represented by circles as are shown in FIG. 6B. Further, the separated portion between the position PD1 (the position coordinate PP is 4) and the position PD2 (position coordinate PP is 4.5) in FIG. 6B corresponds to the separation portion between the position PD11 (the position coordinate PP is 4) and the position PD21 (position coordinate PP is 4.5) in the first case of FIG. 6C. These separated portions are represented by square marks similar to those in FIG. 6B. In any separated portion above, the separated positional relationship (the relationship between the separated portions separated by ½ slot pitch (½ sp) in the first direction (arrow X direction) is established.

On the other hand, the separated portion between the position PE1 (position coordinate PP is 4.25) and the position PE2 (position coordinate PP: 4.75) in FIG. 6 B does not establish the relationship as explained above (separated positional relationship separated in the first direction (arrow X direction) by ½ slot pitch (½ sp)) in the first case of FIG. 6C. Specifically, in the first case of FIG. 6C, there exists a portion indicated by the position PE11 (position coordinate PP is 4.25) corresponding to the position PE1 (position coordinate PP is 4.25) in FIG. 6B. However, there is no portion existed which corresponds to the portion indicated by the position PE2 (position coordinate PP is 4.75) in FIG. 6B. As explained, in the first case, an area ZN1 exists where the above-described relationship (separated positional relationship separated in the first direction (arrow X direction) by ½ slot pitch (½ sp)) is not established. In this case, the area ZN1 is an area of the continuous skew portion 42 from a portion where the skew amount relative to the first reference portion 41 is set by ¼ slot pitch (¼ sp) worth of the plurality of (60) slots 21c to a portion where the skew amount is set by ½ slot pitch (½ sp) worth.

The separated portion between the position PC1 (the position coordinate PP is 3.75) and the position PC2 (the position coordinate PP is 4.25) in FIG. 6B corresponds to the separated portion between the position PC1 (the position coordinate PP is 3.75) and the position PC22 (position coordinate PP is 4.25) in the second case shown in FIG. 6C. These separated portions are represented by circles as are shown in FIG. 6B. Further, the separated portion between the position PD1 (the position coordinate PP is 4) and the position PD2 (position coordinate PP is 4.5) in FIG. 6B corresponds to the separated portion between the position PD12 (the position coordinate PP is 4) and the position PD22 (position coordinate PP is 4.5) in the second case of FIG. 6C. These separated portions are represented by square marks similar to those in FIG. 6B. The separated portion between the position PE1 (the position coordinate PP is 4.25) and the position PE2 (the position coordinate PP is 4.75) in FIG. 6B corresponds to the separated portion between the position PE12 (the position coordinate PP is 4.25) and the position PE22 (position coordinate PP is 4.75) in the second case shown in FIG. 6C. These separated portions are represented by triangles as shown in FIG. 6B. In any separated portion above, the separated positional relationship (the relationship between the separated portions separated by ½ slot pitch (½ sp) in the first direction (arrow X direction) is established.

However, also in the second case of FIG. 6C, an area ZN2 exists where the relationship described above (separated positional relationship separated in the first direction (arrow X direction) by ½ slot pitch (½ sp)) worth is not established in the second case of FIG. 6C. In this case, the area ZN2 is defined to be the area of the continuous skew portion 42 from a portion where the skew amount relative to the first reference portion 41 is set by 1 slot pitch (1 sp) worth of the plurality of (60) slots 21c to a portion where the skew amount is set by 5/4 slot pitch ( 5/4 sp) worth. It is noted that the area ZN2 and the area from the position PC22 to the position PD22 apparently have a separated positional relationship between the separated portions. However, the area from the position PC22 to the position PD22 already has a separated positional relationship the area from the position PC1 to the position PD12. Therefore, considering the mixing, averaging and equalization of the attractive force distribution, here exists no area where the separated positional relationship between the area ZN2 and the separated portions is established.

As explained above, in the case where the maximum value of the skew amount relative to the first reference portion 41 is not set by one slot pitch (1 sp) worth of the plurality of (60) slots 21c, it may be difficult to achieve mixing, averaging and equalization of the attractive force distribution of the mover 30 over the entire third direction (arrow Z direction). Accordingly, according to the embodiment, the maximum skew amount relative to the first reference portion 41 is set to be one slot pitch (1 sp) of the plurality of (60) slots 21c.

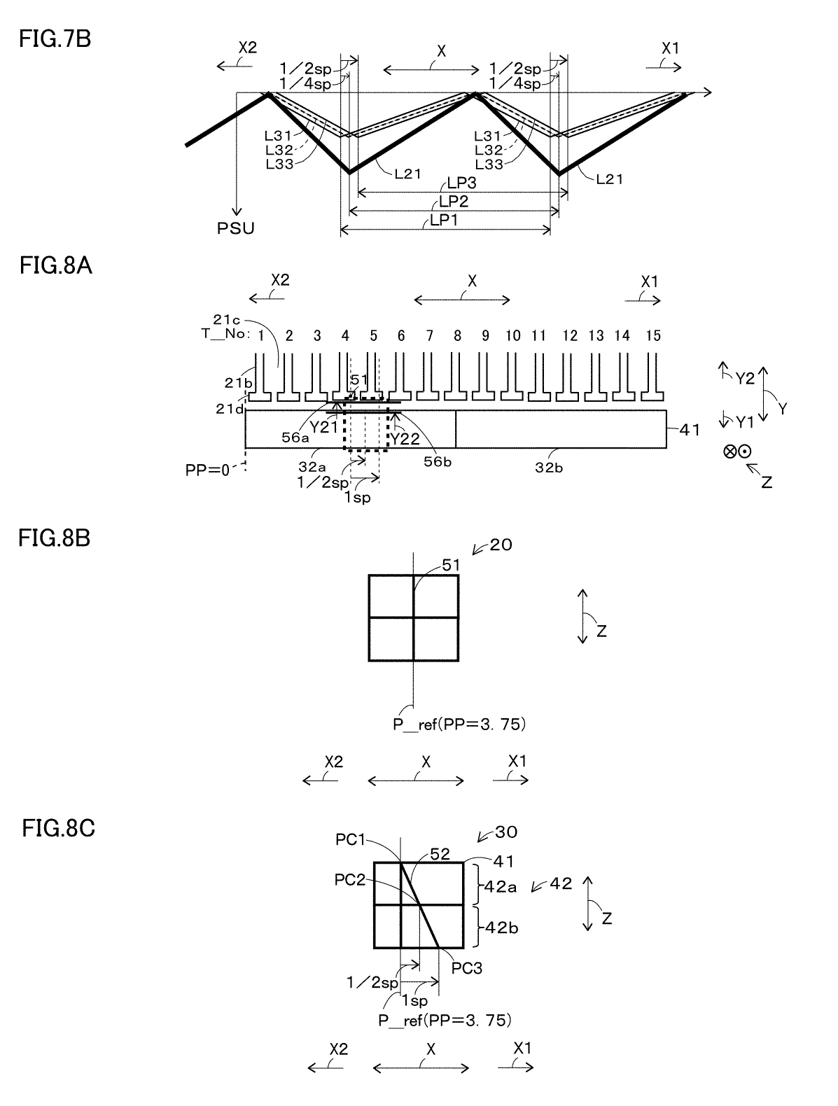

FIG. 7A shows an example of electromagnetic attractive force distribution acting on the plurality of teeth portions 21b in the second direction (arrow Y direction) according to this embodiment. The vertical axis indicates the magnitude PSU of the attractive force and the horizontal axis indicates the first direction (arrow X direction). The solid line L21 indicates an approximate straight line approximating the attractive force distribution per every stator magnetic pole represented by a bar graph by a straight line. This figure shows that by the mixing, averaging and equalization of the attractive force distribution described above, the distribution approaches to the distribution in which the peak value thereof becomes equal at every pole (attractive force distribution in the integer slot structure). It is noted that the attractive force pitch LP0 indicates the interval of the peak value of the attractive force in the first direction (arrow X direction). The attractive force pitch LP0 becomes equalized at each pole.

FIG. 7B is a schematic view for explaining mixing, averaging, and equalization of attractive force distribution per each separated portion. The vertical axis indicates the magnitude PSU of the attractive force and the horizontal axis indicates the first direction (arrow X direction). Mixing and averaging of the attractive force distribution are performed at the separated portion (indicated by circles) between the position PC1 (position coordinate PP is 3.75) and the position PC2 (position coordinate PP is 4.25) in FIG. 6B. As a result, equalization of the attractive force distribution at every pole can be achieved and the component of the eighth space order vibration force increases. The solid line L31 indicates an approximate straight line approximating a first attractive force distribution as the attractive force distribution under this situation with a straight line. Further, the attractive force pitch LP1 indicates an interval of the peak value of the attractive force in the first attractive force distribution in the first direction (arrow X direction). The attractive force pitch LP1 becomes equalized at each pole.

Similarly, mixing and averaging of attractive force distribution are performed between the separated portions (square mark portions) between the position PD1 (position coordinate PP is 4) and the position PD2 (position coordinate PP is 4.5) in FIG. 6B. As a result, equalization of the attractive force distribution at every pole can be achieved and the component of the eighth space order vibration force increases. The broken line L32 indicates an approximate straight line approximating a second attractive force distribution as the attractive force distribution under this situation with a straight line. Further, the attractive force pitch LP2 indicates an interval of the peak value of the attractive force in the second attractive force distribution in the first direction (arrow X direction). The attractive force pitch LP2 becomes equivalent at each pole. Further, mixing and averaging of attractive force distribution are performed between the separated portions (triangle mark portions) between the position PE1 (position coordinate PP is 4.25) and the position PE2 (position coordinate PP is 4.75) in FIG. 6B. As a result, equalization of the attractive force distribution at every pole can be achieved and the component of the eighth space order vibration force of the increases. The solid line L33 indicates an approximate straight line approximating a third attractive force distribution as the attractive force distribution under this situation with a straight line. Further, the attractive force pitch LP3 indicates an interval of the peak values of the attractive force in the third attractive force distribution in the first direction (arrow X direction). The attractive force pitch LP3 becomes equalized at each pole.

The peak value of the attractive force of the second attractive force distribution is shifted by one quarter slot pitch (¼ sp) of the plurality of (60) slots 21c in the one direction (arrow X1 direction) of the first direction (arrow X direction) relative to the first attractive force distribution. Further, the peak value of the attractive force of the third attractive force distribution is shifted by one half slot pitch (½ sp) of the plurality of (60) slots 21c in the one direction (arrow X1 direction) of the first direction (arrow X direction) relative to the first attractive force distribution. Regarding to the entire mover 30, these the highly raised order attractive force distributions are shifted from the minimum zero (0) slot pitch to the maximum ½ slot pitch (½ sp) in the one direction (arrow X1 direction) of the first direction (arrow X direction) added thereto. Thus, the highly raised order of the attractive force distribution is maintained. In other words, as shown in FIG. 7A, the attractive force pitch LP0 also becomes equalized at each pole over the entire mover 30.

It is noted that when FIG. 6A and the solid line L21 in FIG. 7A are referred together at the same time, it can be observed that at the magnetic pole center position 32a3 of the mover magnetic pole 32a and at the magnetic pole center position 32b3 of the mover magnetic pole 32b, the attractive force becomes maximum and the influence thereof on generation of the noise and vibration becomes the largest. On the other hand, the attractive force gradually decreases from the magnetic pole center position 32a3 toward the magnetic pole boundary between the mover magnetic pole 32a and the mover magnetic pole 32b, and the influence on the noise and vibration decreases. This can be applied to the case where the attractive force gradually decreases from the magnetic pole center position 32b3 toward the magnetic pole boundary between the mover magnetic poles 32a and 32b. Considering this fact, in this specification, the influence on the noise and vibration will be explained representing the separated portions positioned along the magnetic pole center position 32a3 of the mover magnetic pole 32a.

According to the rotary electric machine 10 of this embodiment, the mover 30 includes the first reference portion 41 and the continuous skew portion 42. Further, the continuous skew portion 42 is formed such that the maximum value of the skew amount (in this embodiment, one slot pitch (1 sp)) relative to the first reference portion 41 is set so that the maximum value of the relative skew amount between the stator 20 and the mover 30 becomes one slot pitch (1 sp) worth of the plurality of (60) slots 21c. As a result, the rotary electric machine 10 of this embodiment can mix electromagnetic attractive force distributions generated between the stator 20 and the mover 30 over the entire third direction (arrow Z direction) and such distribution can be averaged. Thus, the attractive force distribution becomes equalized at each pole. According to the rotary electric machine 10 of this embodiment, the order of attractive force distribution can be raised to the same extent as that of the integer slot structure rotary electric machine (in this embodiment, eighth order (space eighth order)), it can be possible to raise the number of rotations which agrees to the number of specific vibrations of the stator iron core 21. For example, the number of rotations can be set to the number of rotations outside the range of the driving number of rotations. In other words, the rotary electric machine 10 of this embodiment can avoid occurrence of resonance chances of the stator 20 and reduce noise and vibration of the rotary electric machine 10.

It is preferable that the increase ratio or the decrease ratio of the skew amount in the third direction (arrow Z direction) relative to the first reference portion 41 is set to be constant from the one end side to the other end side of the continuous skew portion 42. In the present specification, it is assumed that when the continuous skew portion 42 is shifted in one direction (arrow X1 direction) of the first direction (arrow X direction) relative to the first reference portion 41, the skew amount of the continuous skew portion 42 increases. Oppositely, when the continuous skew portion 42 is shifted in the other direction (arrow X2 direction) of the first direction (arrow X direction) relative to the first reference portion 41, the skew amount of the continuous skew portion 42 decreases.

Further, as shown in FIG. 6A, one end portion 32a1 of both end portions 32a1 and 32a2 of the mover magnetic pole 32a in the first direction (arrow X direction) of the other end side end surface in the third direction (arrow Z direction) is defined to be the position PA3 (position coordinate PP is 1). Then, the other end portion 32a2 of the both end portions 32a1 and 32a2 of the mover magnetic pole 32a in the first direction (arrow X direction) is set to the position PB3 (position coordinate PP is 8.5). Under this situation, the magnetic pole center position 32a3 of the mover magnetic pole 32a is set to the position PC3 (position coordinate PP is 4.75).

According to the rotary electric machine 10 of this embodiment, the increase ratio of the skew amount relative to the first reference portion 41 is set to be constant from one end side to the other end side of the continuous skew portion 42 in the third direction (arrow Z direction). For example, the increase ratio of the skew amount relative to the position PC1 (the position coordinate PP is 3.75) between the position PC1 (the position coordinate PP is 3.75) and the position PC2 (the position coordinate PP is 4.25) is one half slot pitch (½ sp) worth. Further, the increase ratio of the skew amount relative to the position PC2 (the position coordinate PP is 4.25) between the position PC2 (position coordinate PP is 4.25) and the position PC3 (position coordinate PP is 4.75) is one half slot pitch (½ sp) worth. As explained, the skew amount uniformly increases at a fixed rate from the position PC1 (position coordinate PP is 3.75) over to the position PC3 (position coordinate PP is 4.75).

As described above, since the increase ratio of the skew amount relative to the first reference portion 41 is set to be constant from the one end side to the other end side of the continuous skew portion 42 in the third direction (arrow Z direction), compared to the case of setting the increase ratio of the skew amount relative to the first reference portion 41 to be changeable discontinuously, any leakage of magnetic flux generated mainly in the third direction (arrow Z direction) can be reduced. Further, manufacturing process can be simplified or facilitated. This can be also applied to the case of decrease ratio of the skew amount relative to the first reference portion 41. In such case, the continuous skew portion 42 is gradually shifted relative to the first reference portion 41 in the other direction (arrow X2 direction) of the first direction (arrow X direction) and is arranged in the third direction (arrow Z direction).

Further, according to the rotary electric machine 10 of this embodiment, since the mover 30 is provided with the continuous skew portion 42, torque ripple can be reduced as well as reduction in noise and vibration of the rotary electric machine 10. The torque ripple of the rotary electric machine 10 is a pulsation generated in the output torque of the rotary electric machine 10 and is derived from fluctuation of the magnetic flux variations between the stator 20 and the mover 30 as the mover 30 moves. As an example of such torque ripple, a cogging torque, slot ripple or a pole ripple can be raised. The cogging torque is generated derived from a discontinuous (stepwise) change in the magnetic pole opposing state between the stator magnetic pole and the mover magnetic pole under a non-energized state. According to the rotary electric machine 10 of this embodiment, since the torque ripple tends to increase or decrease in accordance with the increase or decrease in the cogging torque, the torque ripple in this specification will be explained as an example of torque ripple.

As described above, the continuous skew portion 42 is gradually shifted in the first direction (arrow X direction) relative to the first reference portion 41 and arranged in the third direction (arrow Z direction). Further, in this embodiment, the maximum value of the skew amount of the continuous skew portion 42 relative to the first reference portion 41 is set to one slot pitch (1 sp) worth. Therefore, a randomly taken portion of the mover 30 in the first direction (arrow X direction) extends in the first direction (arrow X direction) with a width of one slot pitch (1 sp) worth of the plurality of (60) slots 21c to oppose to the stator 20. Accordingly, the magnetic fluctuation at the opening of the slot 21c of the stator 20 is gradually changed to thereby reduce torque ripple (cogging torque).

It is noted that the fraction slot structure rotary electric machine 10 repeatedly changes the different magnetic pole opposing states in the first direction (arrow X direction) and accordingly, occurrence of torque ripple tends to be less compared to that of the integer slot structure rotary electric machine. According to the rotary electric machine 10 of this embodiment, since the mover 30 is provided with the continuous skew portion 42, the torque ripple (cogging torque) is further reduced. The torque ripple (cogging torque) which derives from the magnetic pole opposing state of the stator magnetic pole and the mover magnetic pole can be still further reduced. Further, according to the rotary electric machine 10 of this embodiment, since the mover 30 is provided with the continuous skew portion 42, a sharp change in the magnetic flux is suppressed and the iron loss, the magnet vortex loss or the copper vortex loss can be prevented.

As described in the Non-Patent Literature 1, in order to reduce exclusively the torque ripple, a continuous skew of 1/c slot pitch worth of the plurality of (60) slots 21c of the stator 20 may be performed (the skew amount relative to the first reference portion 41 is set to 1/c slot pitch). The same effect can be obtained by a continuous skew of n/c slot pitch worth of the plurality of (60) slots 21c of the stator 20 (wherein “n” designates a natural number). It is noted here however, the larger the natural number “n”, the larger the reduction of torque of the rotary electric machine 10 increases. In addition, manufacturing process may become complicated. Accordingly, usually numeral one (1) is selected for the natural number “n”. In this embodiment, in the fraction slot structure rotary electric machine 10, the maximum value of the skew amount (in this embodiment, one slot pitch (1 sp)) of the continuous skew portion 42 relative to the first reference portion 41 is set such that the maximum value of the relative skew amount between the stator 20 and the mover 30 is set to one slot pitch (1 sp) of the plurality of (60) slots 21c. Thus, the torque ripple (cogging torque) and harmonic voltage components included in the output waveform can be reduced in addition to the reduction of noise and vibration of the rotary electric machine 10.

Further, as a countermeasure for reducing the noise, vibration, and torque ripple (cogging torque) of the rotary electric machine 10, each tooth tip portion 21d of the stator iron core 21 or a surface (outer surface) of the mover iron core 31 opposing to the each tooth tip portion 21d is provided with a recess. However, this provision of recess may practically extend the space and compared to the skew method explained above, the torque reduction may increase. The rotary electric machine 10 of the embodiment can reduce the noise, vibration, and torque ripple (cogging torque) of the rotary electric machine 10 keeping suppression of torque reduction.

FIG. 8A shows an example of the magnetic pole opposing state between the plurality of teeth portions 21b and the pair of mover magnetic poles 32a, 32b viewed from the third direction (arrow Z direction). The straight line 56a indicates a part of the inner peripheral surface of the stator 20 in the rotary electric machine 10 (inner rotor type rotary electric machine) in which the mover 30 is provided inside the stator 20. Specifically, the inner peripheral surface of the stator 20 corresponds to the opposing surface of the tooth tip portion 21d which opposes to the mover 30. The straight line 56b indicates a part of the vicinity of outer peripheral surface of the mover 30 in the rotary electric machine 10, in which the mover 30 is provided inside the stator 20. Specifically, the vicinity of the outer peripheral surface of the mover 30 corresponds to the stator 20 side end surface of both end surfaces of the pair of mover magnetic poles 32a, 32b in the second direction (arrow Y direction).

FIG. 8B shows an example of the state of skew of the stator 20. FIG. 8B shows a part of the inner peripheral surface of the stator 20 seen in the vicinity of the straight line 56a of FIG. 8A viewed from the stator side second direction (arrow Y2 direction) which is one direction of the second direction (arrow Y direction) from the mover 30 side towards the stator 20 side. The inner surface of the stator 20 shown in FIG. 8B is shown as a part thereof in the first direction (arrow X direction) and shows the entire thereof in the third direction (arrow Z direction). In FIG. 8A, the showing direction in FIG. 8B is indicated by an arrow Y21.

In this embodiment, the skew amount of the stator 20 is zero. Therefore, the skew position of the stator 20 is formed along in the third direction (arrow Z direction). The straight line 51 indicates the skew position of the stator 20 at the reference position P_ref (for example, the position coordinate PP shown in FIG. 6A is 3.75). The straight line 51 is connected at one end side of the third direction (arrow Z direction) and the other end side of the third direction (arrow Z direction).

FIG. 8C shows an example of the state of skew of the mover 30. This figure shows a part of the vicinity of the outer peripheral surface of the mover 30 in the vicinity of the straight line 56b shown in FIG. 8A viewed from the stator side second direction (arrow Y2 direction). A part of the vicinity of the outer peripheral surface of the mover 30 shown in FIG. 8C is shown in the first direction (arrow X direction) and the entire part is shown in the third direction (arrow Z direction). In FIG. 8A, the showing direction in FIG. 8C is indicated by an arrow Y22.

In this embodiment, the mover 30 includes the first reference portion 41 and the continuous skew portion 42. Therefore, the skew position of the mover 30 is displaced in accordance with the skew amount from one end side to the other end side of the third direction (arrow Z direction). Further, in the continuous skew portion 42, the maximum value of the skew amount relative to the first reference portion 41 is set by one slot pitch (1 sp) of the plurality of (60) slots 21c. The straight line 52 indicates the skew position of the mover 30, and the reference position P_ref (for example, the position coordinate PP is 3.75) on one end side of the third direction (arrow Z direction) and a position separated from the other side of the third direction (arrow Z direction) by one slot pitch (1 sp) (in this case, the position coordinate PP is 4.75) are connected.

It is noted that the portions shown in FIGS. 8A, 8B and 8C correspond to the areas surrounded by the broken line in FIG. 6A. Further, the reference position P_ref of the stator 20 shown in FIG. 8B and the reference position P_ref of the mover 30 shown in FIG. 8C agree with each other. Furthermore, the second embodiment and the embodiments explained hereinafter will be explained case by case based on figures corresponding to FIGS. 8B and 8C. The method of illustration regarding to FIGS. 8B and 8C will be also applicable to the drawings which will appear hereinafter.

### Second Embodiment

In the second embodiment, the stator 20 includes the first reference portion 41 and the continuous skew portion 42, and the mover 30 does not include such portions. This is a different point from the previous embodiment and in the specification, such point which is different from the previous embodiment will be mainly explained.

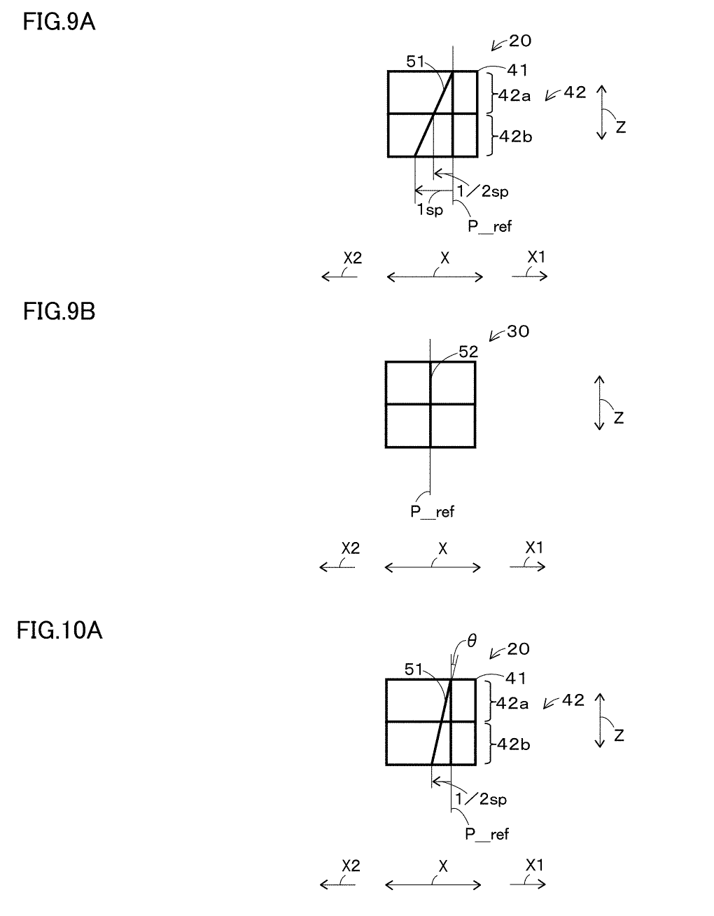

FIG. 9A shows an example of the state of skew of the stator 20. In this embodiment, the stator 20 includes a first reference portion 41 and a continuous skew portion 42. Therefore, the skew position of the stator 20 is displaced in accordance with the skew amount in the third direction (arrow Z direction) from one end side to the other end side thereof. Further, in the continuous skew portion 42, the maximum value of the skew amount relative to the first reference portion 41 is set to the one slot pitch (1 sp) worth of the plurality (60) of slots 21c. The straight line 51 indicates the skew position of the stator 20 and the reference position P_ref on one end side in the third direction (arrow Z direction) and a position separated from the reference position P_ref on the other end side in the third direction (arrow Z direction) by one slot pitch (1 sp) worth are connected.

In this embodiment, the continuous skew portion 42 is gradually shifted in the other direction (arrow X2 direction) of the first direction (arrow X direction) relative to the first reference portion 41 and is arranged in the third direction (arrow Z direction). In more specifically, the plurality of electromagnetic steel plates 21x (continuous skew portions 42) forming the stator iron core 21 is shifted gradually in the other direction (arrow X2 direction) of the first direction (arrow X direction) relative to one (first reference portion 41) of the plurality of electromagnetic steel plates 21x forming the stator iron core 21 and is arranged (layered) in the third direction (arrow Z direction). Similar to the first embodiment, the continuous skew portion 42 can also be shifted in one direction (arrow X1 direction) of the first direction (arrow X direction) relative to the first reference portion 41 and is arranged in the third direction (arrow Z direction).

FIG. 9B shows an example of the state of skew of the mover 30. According to this embodiment, the skew amount of the mover 30 is 0. Therefore, the skew position of the mover 30 is formed along in the third direction (arrow Z direction). The straight line 52 indicates the skew position of the mover 30 at the reference position P_ref, and one end side in the third direction (arrow Z direction) and the other end side in the third direction (arrow Z direction) of the straight line 52 are connected in the third direction (arrow Z direction).

According to the rotary electric machine 10 of this embodiment, the stator 20 includes the first reference portion 41 and the continuous skew portion 42. Further, the maximum value of the skew amount (in this embodiment, one slot pitch (1 sp)) of the continuous skew portion 42 relative to the first reference portion 41 is set so that the maximum value of the relative skew amount between the stator 20 and the mover 30 becomes one slot pitch (1 sp) worth of the plurality (60) slots 21c. Therefore, the rotary electric machine 10 of this embodiment can obtain the same operation and the same effect as those of the first embodiment.

### Third Embodiment

The third embodiment differs from the first embodiment in that both the stator 20 and the mover 30 include the first reference portion 41 and the continuous skew portion 42 according to the third embodiment. In the specification, such different points will be mainly explained.

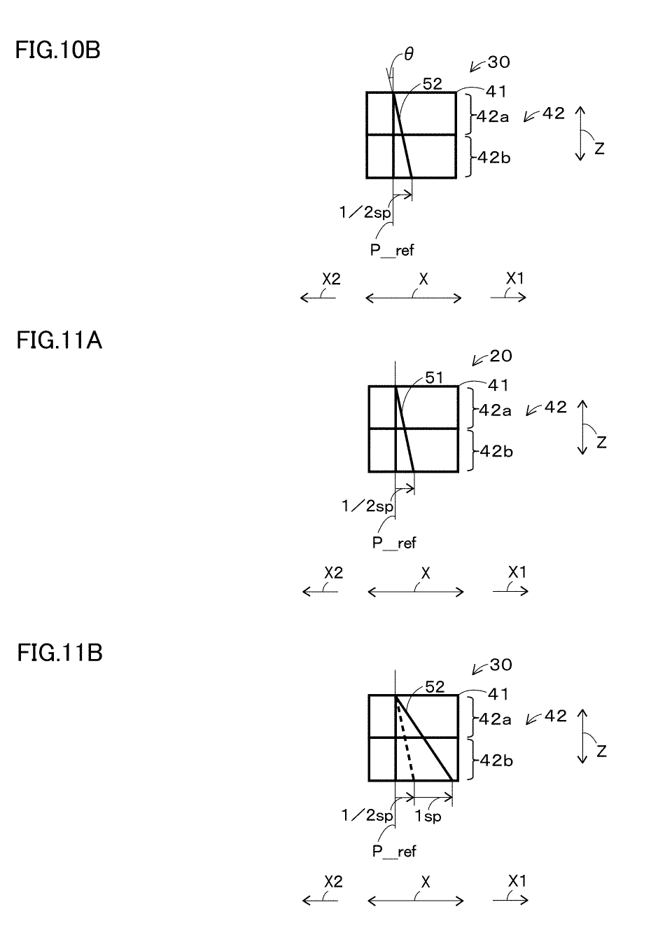

FIG. 10A shows an example of the state of skew of the stator 20. In this embodiment, the stator 20 includes the first reference portion 41 and the continuous skew portion 42. Therefore, the skew position of the stator 20 is displaced in the third direction (arrow Z direction) in accordance with the skew amount from one end side to the other end side of the third direction. Further, in the continuous skew portion 42, the maximum value of the skew amount relative to the first reference portion 41 is set to a half slot pitch (½ sp) worth of the plurality (60) of slots 21c. The straight line 51 indicates the skew position of the stator 20 and is connected at the reference position P_ref on one end side in the third direction (arrow Z direction) and a position separated from the other end side reference position P_ref by ½ slot pitch (½ sp) worth.

FIG. 10B shows an example of the state of skew of the mover 30. In the embodiment, the mover 30 includes the first reference portion 41 and the continuous skew portion 42. Therefore, the skew position of the mover 30 is displaced in the third direction (arrow Z direction) in accordance with the skew amount from one end side to the other end side of the third direction (arrow Z direction). Further, in the continuous skew portion 42, the maximum value of the skew amount relative to the first reference portion 41 is set to the one half slot pitch (½ sp) worth of the plurality (60) of slots 21c. The straight line 52 indicates the skew position of the mover 30, and the reference position P_ref on one end side in the third direction (arrow Z direction) and a position separated from the reference position P_ref on the other end side in the third direction (arrow Z direction) by one half slot pitch (½ sp) worth of the straight line 52 are connected.

The continuous skew portion 42 of the stator 20 is gradually shifted in the other direction (arrow X2 direction) of the first direction (arrow X direction) relative to the first reference portion 41 and is arranged in the third direction (arrow Z direction). Under this situation, the maximum value of the skew amount relative to the first reference portion 41 is set to a half slot pitch (½ sp) worth of the plurality (60) of slots 21c. On the other hand, the continuous skew portion 42 of the mover 30 is gradually shifted in one direction (arrow X1 direction) of the first direction (arrow X direction) relative to the first reference portion 41 and is arranged in the third direction (arrow Z direction). Under this situation, the maximum value of the skew amount relative to the first reference portion 41 is set to a half slot pitch (½ sp) worth of the plurality (60) of slots 21c. Therefore, the relative skew amount between the stator 20 and the mover 30 becomes maximum at the other end side in the third direction (arrow Z direction) of the stator 20 and the mover 30, and the maximum value of the relative skew amount between the stator 20 and the mover 30 becomes one slot pitch (1 sp) worth of the plurality (60) of slots 21c.

As explained above, it is preferable to structure such that when the continuous skew portion 42 of one of the stator 20 and the mover 30 (in this embodiment, the mover 30) is shifted in one (arrow direction X1) of the first direction (arrow X direction) relative to the first reference portion 41, the continuous skew portion 42 of the other of the stator 20 and the mover 30 (in this embodiment, the stator 20) is shifted in the other (arrow direction X2) of the first direction (arrow X direction) relative to the first reference portion 41. Further, it is preferable to structure such that the maximum value of the skew amount in the continuous skew portion 42 of the stator 20 is equal to the maximum value of the skew amount in the continuous skew portion 42 of the mover 30 (in this embodiment, the maximum value of the skew amount is set to one half slot pitch (½ sp) worth of the plurality of (60) slots 21c).

FIG. 11A shows an example of the state of skew of the stator 20 in the first comparative embodiment. In the present comparative embodiment, the continuous skew portion 42 of the stator 20 is gradually shifted in one direction (arrow X1 direction) of the first direction (arrow X direction) relative to the first reference portion 41 and is arranged in the third direction (arrow Z direction). Under this situation, the maximum value of the skew amount relative to the first reference portion 41 is set to one half slot pitch (½ sp) worth of the plurality (60) of slots 21c. The straight line 51 indicates the skew position of the stator 20, and the reference position P_ref on one end side in the third direction (arrow Z direction) and a position separated from the reference position P_ref on the other end side in the third direction (arrow Z direction) by one half slot pitch (½ sp) worth are connected.

FIG. 11B relates to the first comparative embodiment, and shows an example of the state of skew of the mover 30. In the present comparative embodiment, the continuous skew portion 42 of the mover 30 is gradually shifted in one direction (arrow X1 direction) of the first direction (arrow X direction) relative to the first reference portion 41 and is arranged in the third direction (arrow Z direction). Under this situation, the maximum value of the skew amount of the continuous skew portion 42 relative to the first reference portion 41 is set to be equal to the 3/2 slot pitch (½ sp+1 sp) worth of the plurality (60) of the slots 21c. The straight line 52 indicates the skew position of the mover 30 and the reference position P_ref on one end side in the third direction (arrow Z direction) and a position separated from the reference position P_ref on the other end side in the third direction (arrow Z direction) by 3/2 slot pitch (½ sp+1 sp) are connected. Therefore, the relative skew amount between the stator 20 and the mover 30 becomes maximum at the other end side in the third direction (arrow Z direction) of the stator 20 and the mover 30 and the maximum value of the relative skew amount between the stator 20 and the mover 30 becomes equal to one slot pitch (1 sp) worth of the plurality (60) of slots 21c.

As explained above, in the first comparative embodiment, the stator 20 and the mover 30 are arranged such that the continuous skew portion 42 is shifted in the same direction (in this case, in one direction (arrow X1 direction) of the first direction (arrow X direction) relative to the first reference portion 41. Therefore, the maximum value of the skew amount in the continuous skew portion 42 of the mover 30 is set to be equal to the 3/2 slot pitch (½ sp+1 sp) worth of the plurality (60) of slots 21c. In other words, according to the first comparative embodiment, the maximum value of the skew amount in the continuous skew portion 42 of the mover 30 increases compared with the cases of the present (third) embodiment and the first embodiment.

According to the rotary electric machine 10 of this embodiment, both the stator 20 and the mover 30 are provided with the first reference portion 41 and the continuous skew portion 42. Further, when the continuous skew portion 42 of the mover 30 is shifted in one direction (arrow X1 direction) of the first direction (arrow X direction) relative to the first reference portion 41, the continuous skew portion 42 of the stator 20 is shifted in the other direction (arrow X2 direction) of the first direction (arrow X direction) relative to the first reference portion 41. Thus, the skew amount according to the rotary electric machine 10 of this embodiment can be more reduced, compared with the case where skew is performed only by one of the stator 20 and the mover 30. In the rotary electric machine 10 of this embodiment, the continuous skew portions 42, 42 of the stator 20 and the mover 30 are shifted mutually in the opposite directions of the first direction (arrow X direction) and accordingly, compared to the case where both of the continuous skew portions 42, 42 are shifted in the same direction, an increase in the skew amount can be suppressed. Therefore, the rotary electric machine 10 of this embodiment can suppress an increase in torque reduction derived from an increase in skew amount. In the rotary electric machine 10 of this embodiment, a leakage of magnetic flux can be reduced by reducing the skew amount. In addition, deterioration of workability in manufacturing process accompanied by an increase in skew amount can be suppressed.

The above-mentioned advantageous effect becomes more apparent as the number of the plurality of slots 21c of the stator 20 decreases. As explained above, in an 8-pole and 60-slot structure rotary electric machine (a rotary electric machine whose basic structure is that the number of magnetic poles of the mover 30 is 2 and the number of slots of the stator 20 is 15), one (1) slot pitch (1 sp) worth corresponds to an electric angle of 24° (=360°/15 slots). On the other hand, for example, in an 8-pole and 36-slot structure rotary electric machine (a rotary electric machine whose basic structure is that the number of magnetic poles of the mover 30 is 2 and the number of slots of the stator 20 is 9), one (1) slot pitch worth corresponds to an electric angle of 40° (=360°/9 slots). In other words, the skew amount increases in the 8 pole and 36 slot structure rotary electric machine, compared with that of the 8 pole and 60 slot structure rotary electric machine. Since the skew amount can be more reduced in the rotary electric machine 10 of this embodiment compared with the type where the skewing is performed by only one of the stator 20 and the mover 30, it is particularly preferable to apply the present invention to the rotary electric machine 10 having less number of slots 21c stator 20.

The above can be said to the case where the continuous skew portion 42 of the mover 30 is shifted in the other direction (arrow X2 direction) of the first direction (arrow X direction) relative to the first reference portion 41 when the continuous skew portion 42 of the stator 20 is shifted in one direction (arrow X1 direction) of the first direction (arrow X direction) relative to the first reference portion 41. In other words, it is preferable to structure such that when the continuous skew portion 42 of one of the stator 20 and the mover 30 is shifted in one direction (arrow X1 direction) of the first direction (arrow X direction) relative to the first reference portion 41, the continuous skew portion 42 of the other of the stator 20 and the mover 30 is shifted in the other direction (arrow X2 direction) of the first direction (arrow X direction) relative to the first reference portion 41.

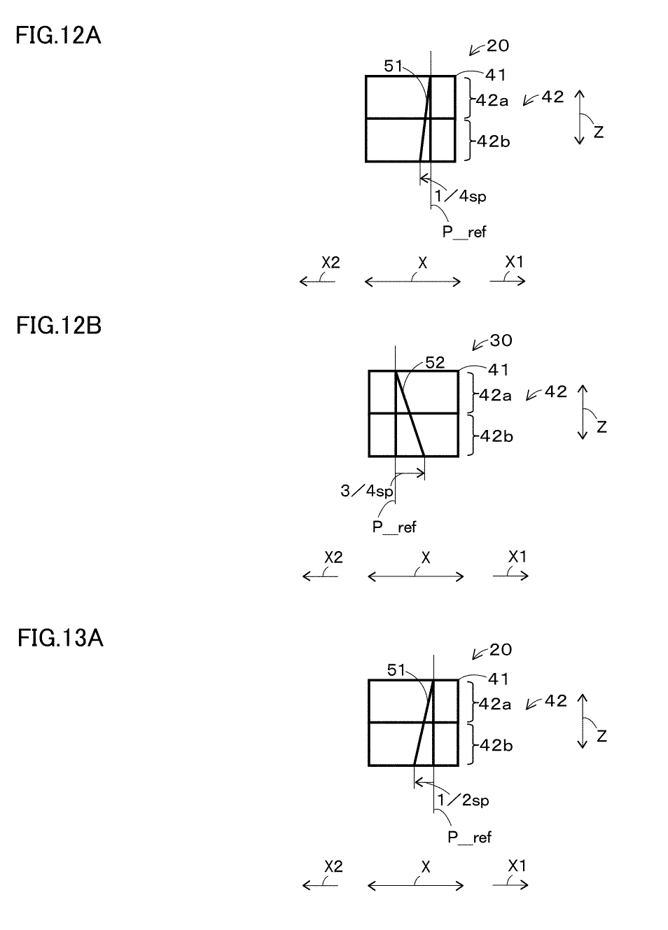

FIG. 12A shows an example of the state of skew of the stator 20 according to the second comparative embodiment. In the comparative embodiment, the continuous skew portion 42 of the stator 20 is gradually shifted in the other direction (arrow X2 direction) of the first direction (arrow X direction) relative to the first reference portion 41 and is arranged in the third direction (arrow Z direction). Under this situation, the maximum value of the skew amount of the continuous skew portion 42 relative to the first reference portion 41 is set to be equal to one quarter slot pitch (¼ sp) worth of the plurality (60) of slots 21c. The straight line 51 indicates the skew position of the stator 20 and the reference position P_ref on one end side in the third direction (arrow Z direction) and a position separated from the reference position P_ref on the other end side in the third direction (arrow Z direction) by one quarter slot pitch (¼ sp) worth are connected.

FIG. 12B shows an example of the state of skew of the mover 30 according to the second comparative embodiment. In the present comparative embodiment, the continuous skew portion 42 of the mover 30 is gradually shifted in one direction (arrow X1 direction) of the first direction (arrow X direction) relative to the first reference portion 41 and is arranged in the third direction (arrow Z direction). Under this situation, the maximum value of the skew amount of the continuous skew portion 42 relative to the first reference portion 41 is set to be equal to three quarter slot pitch (¾ sp) worth of the plurality (60) of slots 21c. The straight line 52 indicates the skew position of the mover 30 and the reference position P_ref on one end side in the third direction (arrow Z direction) and a position separated from the reference position P_ref on the other end side in the third direction (arrow Z direction) by ¾ slot pitch (¾ sp) worth are connected. Therefore, the relative skew amount between the stator 20 and the mover 30 becomes maximum at the other end side in the third direction (arrow Z direction) and the maximum value of the relative skew amount between the stator 20 and the mover 30 is equal to one slot pitch (1 sp) worth of the plurality (60) of slots 21c.

As explained above, in the second comparative embodiment, the maximum value of the skew amount of the continuous skew portion 42 of the stator 20 is different from the maximum value of the skew amount of the continuous skew portion 42 of the mover 30. As a result, in this comparative embodiment, the skew amount of the continuous skew portion 42 of the mover 30 increases as compared with the case of this embodiment. When the skew amount of the continuous skew portion 42 of the mover 30 increases as compared with the continuous skew portion 42 of the stator 20, particularly when the permanent magnet (four sets of pair of mover magnetic poles 32a, 32b) is made by sintering, there may occur reduction of workability when mounting the permanent magnet on the magnet housing portion of the mover iron core 31. It is noted that the skew amount of the continuous skew portion 42 of the stator 20 more increases than the skew amount of the continuous skew portion 42 of the mover 30. However, in such case, there may occur a reduction of workability when assembling stator coil 22 into the plurality (60) of slots 21c of the stator iron core 21.

According to the rotary electric machine 10 of this embodiment, the maximum value of the skew amount of the continuous skew portion 42 of the stator 20 is equal to the maximum value of the skew amount of the continuous skew portion 42 of the mover 30 (one half slot pitch (½ sp) worth of the plurality of (60) slot 21c). Therefore, in the rotary electric machine 10 of this embodiment, the skew amount can be uniformly dispersed in both the stator 20 and the mover 30 and the complexity of manufacturing the stator 20 and the mover 30 with skewing can be proportionally dispersed which can improve workability in the manufacturing process.

As shown in FIG. 10A, the angle formed by a straight line extending along in the third direction (arrow Z direction) and the straight line 51 is set as an inclination angle θ of skew. As shown in FIG. 10B, the angle formed by the straight line extending along the third direction (arrow Z direction) and the straight line 52 is the same as an inclination angle of skew. Even with the same skew amount, the inclination angle θ of skew is different due to the difference in the physique of the rotary electric machine 10. In other words, even under the state that the stator iron core 21 has the same inner diameter (the same dimension in the second direction (arrow Y direction)) and that the mover iron core 31 has the same outer diameter (the same dimension in the second direction (arrow Y direction)), when the axial length (dimension in the third direction (arrow Z direction)) increases, the inclination angle θ of skew becomes small, magnetic leakage in the axial direction (third direction (arrow Z direction)), complexity in manufacturing process can be reduced. Even with the same skew amount, the manufacturing difficulty may differ depending on each structure of the stator 20 and the mover 30. Considering the above issues comprehensively, it may be possible to increase the amount of skew at the side of stator 20 and the mover 30 where the difficulty in manufacturing is less affected and reduce the amount of skew at the other side where the difficulty in manufacturing is more affected. As explained above, the maximum value of the skew amount of the continuous skew portion 42 of the stator 20 relative to the first reference portion 41 and the maximum value of the skew amount of the continuous skew portion 42 of the mover 30 relative to the first reference portion 41 can be appropriately set such that the maximum value of the relative skew amount between the stator 20 and the mover 30 is set to be equal to one slot pitch (1 sp) worth of the plurality (60) of the slots 21c considering the physical structure and required specification of the rotary electric machine 10.

### Fourth Embodiment

In this embodiment, the stator 20 includes the first reference portion 41 and the continuous skew portion 42 and the mover 30 includes a second reference portion 43 and a step skew portion 44. This is the different point from the first embodiment. In this specification, this difference from the first embodiment will be mainly explained.

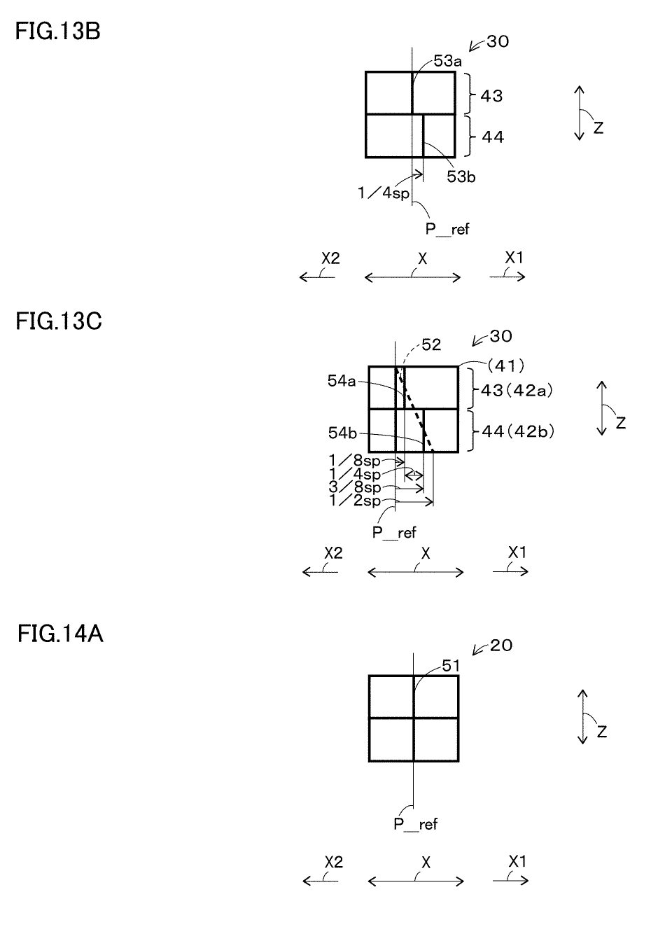

FIG. 13A shows an example of the state of skew of the stator 20. In this embodiment, the stator 20 includes the first reference portion 41 and the continuous skew portion 42. Therefore, the skew position of the stator 20 is shifted in the third direction (arrow Z direction) in accordance with the skew amount from one end to the other end of the third direction. The continuous skew portion 42 is gradually shifted in the other direction (arrow X2 direction) of the first direction (arrow X direction) relative to the first reference portion 41 and is arranged in the third direction (arrow Z direction). Under this situation, the maximum value of the skew amount of the continuous skew portion 42 relative to the first reference portion 41 is set to one half slot pitch (½ sp) worth of the plurality (60) of slots 21c. The straight line 51 indicates the skew position of the stator 20 and the reference position P_ref on one end side in the third direction (arrow Z direction) and a position separated from the reference position P_ref on the other end side in the third direction (arrow Z direction) by one half slot pitch (½ sp) worth are connected.

FIG. 13B shows an example of the state of skew of the mover 30. In this embodiment, the mover 30 includes a second reference portion 43 and a step skew portion 44. The second reference portion 43 is a portion which is used as a reference of skew. The step skew portion 44 is a portion disposed in the third direction (arrow Z direction) being shifted stepwise in the first direction (arrow X direction) relative to the second reference portion 43. In this embodiment, the step skew portion 44 is stepwise (one step) shifted in one direction (arrow X1 direction) of the first direction (arrow X direction) relative to the second reference portion 43 and is arranged in the third direction (arrow Z direction). It is noted here that also in this embodiment, the reference position P_ref (the reference position of the first reference portion 41) of the stator 20 and the reference position P_ref (the reference position of the second reference portion 43) of the mover 30 agree with each other.

The skew amount of the step skew portion 44 relative to the second reference portion 43 is set to one half of the maximum value of the skew amount of the continuous skew portion 42 relative to the first reference portion 41. As explained above, in this embodiment, the maximum value of the skew amount of the continuous skew portion 42 of the stator 20 relative to the first reference portion 41 is equal to one half slot pitch (½ sp) worth of the plurality (60) of slots 21c. Therefore, the skew amount of the step skew portion 44 of the mover 30 relative to the second reference portion 43 is set to be equal to the one quarter slot pitch (¼ sp) worth of the plurality (60) of the slots 21c. As a result, the relative skew amount between the stator 20 and the mover 30 becomes maximum at the other end side in the third direction (arrow Z direction) of the stator 20 and the mover 30 and the maximum value of the relative skew amount between the stator 20 and the mover 30 becomes one slot pitch (1 sp) worth of the plurality (60) of slots 21c.

FIG. 13C shows a method of converting the respective skew amounts of the continuous skew portion 42 and the step skew portion 44. In this embodiment, the continuous skew portion 42 of the stator 20 is gradually shifted relative to the first reference portion 41 in the other direction (arrow X2 direction) of the first direction (arrow X direction) and is arranged in the third direction (arrow Z direction). Under this situation, the maximum value of the skew amount relative to the first reference portion 41 is set to one half slot pitch (½ sp) worth of the plurality (60) of slots 21c. Therefore, if the mover 30 includes the first reference portion 41 and the continuous skew portion 42, as described in the third embodiment, it is preferable to structure such that the continuous skew portion 42 of the mover 30 is shifted in one direction (arrow X1 direction) of the first direction (arrow X direction) and is arranged in the third direction (arrow Z direction). Further, it is also preferable to structure such that the maximum value of the skew amount relative to the first reference portion 41 is set to one half slot pitch (½ sp) worth of the plurality (60) of the slots 21c. The straight line 52 shown in FIG. 13C indicates a virtual skew position when the mover 30 includes the first reference portion 41 and the continuous skew portion 42.

The maximum value of the skew amount of the continuous skew portion 42 relative to the first reference portion 41 as explained above (in this case, the maximum value is one half slot pitch (½ sp) worth of the plurality of (60) slots 21c) is converted into the skew amount of the step skew portion 44 relative to the second reference portion 43. As shown in the figure, the center position 54a of the continuous skew in the first continuous skew portion 42a (corresponding to the second reference portion 43 of the step skew) corresponds to a position shifted from the reference position P_ref in one direction (arrow X1 direction) of the first direction (arrow X direction) by one eighth slot pitch (⅛ sp) worth of the plurality of (60) slots 21c. Further, the center position 54b of the continuous skew in the second continuous skew portion 42b (corresponding to the step skew portion 44) corresponds to a position shifted from the reference position P_ref in one direction (arrow X1 direction) of the first direction (arrow X direction) by three eighths slot pitch (⅜ sp) worth of the plurality of (60) slots 21c.

The difference between the center position 54a of the first continuous skew portion 42a and the center position 54b of the second continuous skew portion 42b (in this case, the difference is ¼ slot pitch (¼ sp) worth of the plurality (60) of slots 21c) corresponds to the skew amount of the step skew portion 44 relative to the second reference portion 43. It is noted that when the center position 54a of the first continuous skew portion 42a is shifted in the other direction (arrow X2 direction) of the first direction (arrow X direction) by one eighth slot pitch (⅛ sp) worth of the plurality (60) of slots 21c, the position agrees with the reference position P_ref. and this position is illustrated in FIG. 13B as the center position 53a of the second reference portion 43. Further, when the center position 54b of the second continuous skew portion 42b is shifted in the other direction (arrow X2 direction) of the first direction (arrow X direction) by one eighth slot pitch (⅛ sp) worth of the plurality (60) of the slots 21c, the position agrees with the center position 53b of the step skew portion 44 as illustrated in FIG. 13B.

According to the rotary electric machine 10 of this embodiment, the stator 20 includes the first reference portion 41 and the continuous skew portion 42 and the mover 30 includes the second reference portion 43 and the step skew portion 44. Further, the skew amount of the step skew portion 44 relative to the second reference portion 43 is equal to one half of the maximum value of the skew amount of the continuous skew portion 42 relative to the first reference portion 41 (in this embodiment, the skew amount is one quarter slot pitch (¼ sp) worth of the plurality of (60) slots 21c). Therefore, the rotary electric machine 10 of this embodiment can reduce the complexity in manufacturing of the stator 20 and the mover 30 which accompanies the skew and at the same time can improve the workability in the manufacturing process. In more specifically, considering workability upon assembling of the stator coil 22 to the plurality (60) slots 21c of the stator iron core 21, the stator 20 is better to have a continuous skew portion 42, rather than to have the step skew portion 44. On the other hand, considering the case where the sintered permanent magnets (four pairs of mover magnetic poles 32a, 32b) are used, considering the workability when the permanent magnets are attached to the magnet housing portion of the mover core 31, the mover 30 Is preferably provided with a step skew portion 44 rather than to be provided with the continuous skew portion 42. With the above-described structure, the rotary electric machine 10 of this embodiment can improve workability in manufacturing process in both the stator 20 and the mover 30.

It is noted here that the continuous skew portion 42 of the stator 20 can also be gradually shifted in one direction (arrow X1 direction) of the first direction (arrow X direction) relative to the first reference portion 41 and be arranged in the third direction (arrow Z direction). In such case, the step skew portion 44 of the mover 30 is shifted stepwise (one step) in the other direction (arrow X2 direction) of the first direction (arrow X direction) relative to the second reference portion 43. In other words, it is preferable to structure such that when the continuous skew portion 42 of the stator 20 is shifted in one direction (arrow X1 direction) of the first direction (arrow X direction) relative to the first reference portion 41, the mover 30 is skewed in the other direction (arrow X2 direction) of the first direction (arrow X direction) relative to the second reference portion 43. Therefore, the same operation and effect as those described in the third embodiment can be obtained.

Further, the step skew portion 44 may be stepwise (a plurality of steps) shifted in the first direction (arrow X direction) relative to the second reference portion 43 and is arranged in the third direction (arrow Z direction). In such case, as similar to the case of one step shifting shown in FIG. 13C, each center position of the continuous skew and each center position of stepped skew are made to agree to each other to convert the skew amount relative to the second reference portion 43 in each step of the step skew portion 44.

As shown in the first to third embodiments and this (fourth) embodiment, at least one of the stator 20 and the mover 30 includes the first reference portion 41 and the continuous skew portion 42. Further, in the continuous skew portion 42, the maximum value of the skew amount relative to the first reference portion 41 is set such that the maximum value of the relative skew amount between the stator 20 and the mover 30 becomes equal to one slot pitch (1 sp) worth of the plurality (60) of slots 21c. Furthermore, in any of the embodiments described above, it is preferable to structure that the continuous skew portion 42 is formed such that the increase ratio or decrease ratio in the skew amount relative to the first reference portion 41 from one end side to the other end side in the third direction (arrow Z direction) is set to be constant. Thus, the same operation and effect as those described in the first embodiment can be achieved.

### Fifth Embodiment

In this embodiment, the first reference portion 41 includes a third direction one end side first reference portion 41a and a third direction another end side first reference portion 41b and the continuous skew portion 42 includes a third direction one end side continuous skew portion 45a and a third direction another end side continuous skew portion 45b. This is the different point from the first embodiment. In this specification, differences from the first embodiment will be mainly explained.

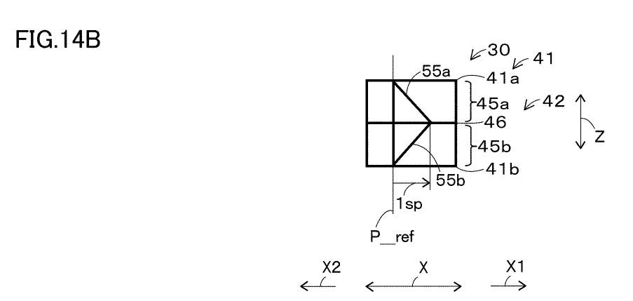

FIG. 14A shows an example of the state of skew of the stator 20. In this embodiment, the skew amount in the stator 20 is zero. Accordingly, the skew position of the stator 20 is formed along in the third direction (arrow Z direction). The straight line 51 indicates the skew position of the stator 20 at the reference position P_ref and one end side in the third direction (arrow Z direction) and the other end side in the third direction (arrow Z direction) of the line are connected in the third direction (arrow Z direction).

FIG. 14B shows an example of the state of skew of the mover 30. In this embodiment, the mover 30 includes the first reference portion 41 and the continuous skew portion 42. However, in this embodiment, the first reference portion 41 includes a third direction one end side first reference portion 41a and a third direction another end side first reference portion 41b. The third direction one end side first reference portion 41a is the first reference portion 41 which is provided on one end side in the third direction (arrow Z direction). The third direction another end side first reference portion 41b is the first reference portion 41 which is provided on another end side in the third direction (arrow Z direction).

Further, the continuous skew portion 42 is provided with a third direction one end side continuous skew portion 45a and a third direction another end side continuous skew portion 45b. The third direction one end side continuous skew portion 45a is a portion of the continuous skew portion 42 in which half portion at one end side in the third direction (arrow Z direction) is gradually shifted in one direction (arrow X1 direction) of the first direction (arrow X direction) from the third direction one end side first reference portion 41a and is arranged up to the center portion 46 in the third direction (arrow Z direction). The third direction another end side continuous skew portion 45b is a portion of the continuous skew portion 42 in which half portion at another (the other) end side in the third direction (arrow Z direction) is gradually shifted in the other direction (arrow X2 direction) of the first direction (arrow X direction) from the center portion 46 and is arranged up to the third direction another end side first reference portion 41b. Also in this embodiment, the reference position P_ref of the stator 20 and the reference position P_ref of the mover 30 (the reference position of the third direction one end side first reference portion 41a and the reference position of the third direction another end side first reference portion 41b ) agree with each other.

The maximum value of the skew amount in the third direction one end side continuous skew portion 45a relative to the third direction one end side first reference portion 41a is set to be equal to one slot pitch (1 sp) worth of the plurality (60) of slots 21c. The straight line 55a indicates the skew position of the mover 30 and the reference position P_ref on one end side in the third direction (arrow Z direction) and a position separated from the center portion 46 of the reference position P_ref in the third direction (arrow Z direction) by one slot pitch (1 sp) worth are connected. Similarly, the maximum value of the skew amount in the third direction another end side continuous skew portion 45b relative to the third direction another end side first reference portion 41b is set to be equal to one slot pitch (1 sp) worth of the plurality (60) of slots 21c. The straight line 55b indicates the skew position of the mover 30 and a position separated from the center portion 46 of the reference position P_ref in the third direction (arrow Z direction) by one slot pitch (1 sp) worth and the reference position P_ref on the other end side in the third direction (arrow Z direction) are connected. As a result, the relative skew amount between the stator 20 and the mover 30 at the center portion 46 in the third direction (arrow Z direction) of the stator 20 and the mover 30 becomes the maximum and the maximum value of the relative skew amount between the stator 20 and the mover 30 becomes equal to one slot pitch (1 sp) worth of the plurality (60) of slots 21c.

According to the rotary electric machine 10 of this embodiment, the mover 30 includes the first reference portion 41 and the continuous skew portion 42. The first reference portion 41 is provided with a third direction one end side first reference portion 41a and a third direction another end side first reference portion 41b. The continuous skew portion 42 is provided with a third direction one end side continuous skew portion 45a and a third direction another end side continuous skew portion 45b. Further, the maximum value (in this embodiment, one slot pitch (1 sp) of the plurality (60) of slots 21c) of the skew amount relative to the first reference portion 41 (third direction one end side reference portion 41a , third direction another end side first reference portion 41b) is set such that the maximum value of the relative skew amount between the stator 20 and the mover 30 becomes equal to one slot pitch (1 sp) worth of the plurality (60) of slots 21c. Therefore, the rotary electric machine 10 of this embodiment can obtain the same operation and effect as those already explained in the first embodiment.

Further, it is preferable to set increase ratio of the skew amount in the third direction one end side continuous skew portion 45a relative to the third direction one end side first reference portion 41a to be constant from one end side in the third direction (arrow Z direction) to the center portion 46 and at the same time to set decrease ratio of the skew amount in the third direction another end side continuous skew portion 45b relative to the third direction another end side first reference portion 41b to be constant from the center portion 46 in the third direction (arrow Z direction) to the other end side. Further, it is also preferable to set that the absolute value of the increase ratio of the skew amount and the absolute value of the decrease ratio of the skew amount are set to the same value. Then, a leakage of magnetic flux can be more reduced than a case where the skew amount relative to the first reference portion 41 (the third direction one end side first reference portion 41a and the third direction another end side first reference portion 41b) changes discontinuously. Further, the manufacturing process can be simplified.

Further, in the rotary electric machine 10 of this embodiment, since the continuous skew portion 42 includes the third direction one end side continuous skew portion 45a and the third direction another end side continuous skew portion 45b, the symmetry in the third direction (arrow Z direction) can be assured to be able to reduce a twisted resonance. It is noted that if a sintered permanent magnet (four pairs of mover magnetic poles 32a, 32b) is used, a workability for mounting the permanent magnets on the magnet housing may be deteriorated. In such case, it is preferable to divide the permanent magnet into two equivalent pieces by bisecting the permanent magnet along the first direction (arrow X direction) on a plane perpendicular to the third direction (arrow Z direction). By mounting one piece of the divided permanent magnet from one end side in the third direction (arrow Z direction) and mounting the other piece of the divided permanent magnet from another end side in the third direction (arrow Z direction), such deterioration of workability can be reduced.

In this embodiment, the distance in the third direction (arrow Z direction) of the separated portions (portions separated in the first direction (arrow X direction) by one half slot pitch (½ sp)) as explained in the first embodiment is reduced to one half as that of the first embodiment. Accordingly, in this embodiment, higher order attractive force distribution can be effectively achieved. Further, according to this embodiment, it is preferable to elongate an axial length of the stator 20 and the mover 30 in third direction (arrow Z direction). Still further, the structure used in this embodiment may be repeatedly used in the third direction (arrow Z direction). Further, in the continuous skew portion 42, the number of portions gradually shifted in one direction (arrow X1 direction) of the first direction (arrow X direction) and the number of portions gradually shifted in the other direction (arrow X2 direction) of the first direction (arrow X direction) may not be the same. These modifications may be appropriately and selectively made depending on the physique or required specification of the rotary electric machine 10. It is noted here that in the first embodiment, in order to obtain the same operation and effect, multi-skews in which the structure of the first embodiment is repeatedly used in the third direction (arrow Z direction) can be considered. However, such structure is not appropriate because a discontinuous portion in the first direction (arrow X direction) may be generated between each skew of the multi-skews and a leakage of magnetic flux may occur which may lead to a reduction of output torque etc.

### Sixth Embodiment

This embodiment differs from the first embodiment in the number of slots per every pole and every phase. The rotary electric machine 10 of this embodiment is an eight (8) pole, thirty (30) slot structure rotary electric machine and the number of slots per every pole and every phase is 1.25, i.e., the embodiment shows the ¼ series rotary electric machine 10. The specification explains mainly the different points from the first embodiment.

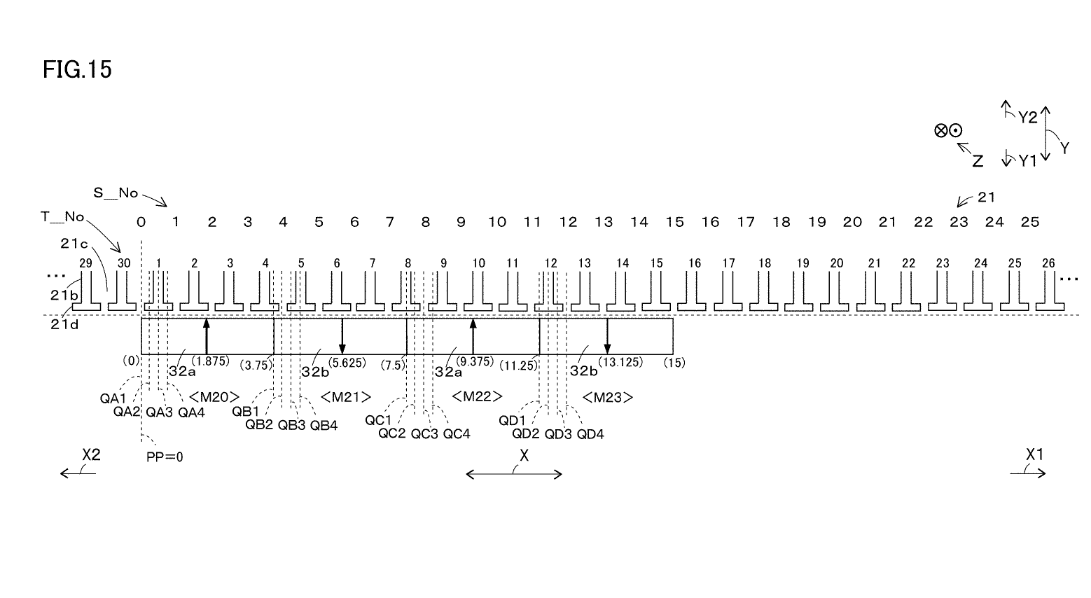

FIG. 15 shows an example of the magnetic pole opposing state between the plurality of teeth portions 21b and two pairs of mover magnetic poles 32a, 32b according to the reference embodiment. The rotary electric machine 10 of the reference embodiment is an eight (8) pole, thirty (30) slot structure rotary electric machine and the number of slots per every pole and every phase is 1.25, i.e., the reference embodiment shows the ¼ series rotary electric machine 10.

As shown in FIG. 15, in this reference embodiment, situation that the mover magnetic poles 32a, 32b of two pairs of magnetic poles (four magnetic poles) worth which are mutually located adjacent to one another in the first direction (arrow X direction) will be considered. The quarter (¼ ) series rotary electric machine 10 has four kinds of magnetic pole opposing states (the magnetic pole opposing state M20, the magnetic pole opposing state M21, the magnetic pole opposing state M22 and the magnetic pole opposing state M23) and four kinds of attractive force distributions. Therefore, two pairs of mover magnetic poles 32a, 32b of worth magnetic poles (four magnetic poles) which are adjacently located in the first direction (arrow X direction) are different in the attractive force distributions. As a result, distributions of the attractive force acting on the plurality of teeth portions 21b are not equivalent per each magnetic pole but are equivalent per each two pairs of magnetic poles (per four magnetic poles).

The same can be said to other two pairs of the mover magnetic poles 32a and 32b (not shown). As described above, according to the ¼ series rotary electric machine 10, the pole multiplication (in this embodiment, eight pole multiplication) is achieved by moving the mover magnetic poles 32a, 32b which are two pairs of magnetic poles adjacently located in the first direction (arrow X direction) and which attractive force distributions are different from one another, as a unit in a direction parallel with the first direction (arrow X direction).

In the ¼ series rotary electric machine 10, when displacing the stator iron core 21 in the second direction (arrow Y direction), four different magnitude peak values are generated in the displacement amount. Accordingly, the ¼ series eight (8) pole rotary electric machine 10 has the component of second order (space second order) vibration force per one turn of the stator iron core 21. The second order (space second order) vibration force per one turn of the stator iron core 21 is repeated with the two pairs (four) magnetic poles as a unit and in the four pairs of magnetic poles (eight magnetic poles) in the first direction (arrow X direction), two peak values are generated in the amount of displacement of the stator iron core 21 in the second direction (arrow Y direction). In this case, as shown in FIG. 5C, the stator iron core 21 tends to be deformed into an elliptical shape indicated by the curve 21s2.

As described above, even in the ¼ series rotary electric machine 10, lower order of vibration force component (in this embodiment, second order (space second order)) is provided which is lower than the number of orders (eighth order (space eighth order) in this embodiment) decided depending on the number of magnetic poles of the mover 30 (in this embodiment, eight poles). Therefore, in the rotary electric machine 10 having a wide range of the driving number of rotations, the number of rotation which agrees with the specific number of rotations of the stator iron core 21 may be easily generated within the range of the driving number of rotations. As a result, resonance occurs in the stator 20 and the noise and vibration of the rotary electric machine 10 may increase. Therefore, in this embodiment, the order of the attractive force distribution is increased to the same extent (eighth order (space eighth order) in this embodiment) as the integer slot structure rotary electric machine.

As shown in FIG. 15, at the position QA1 (the position coordinate PP is 0), the mover magnetic pole 32a is opposed to the center position of the slot 21c. At the position QB1 (the position coordinate PP is 3.75), the mover magnetic pole 32b is displaced from the center position of the teeth portion 21b in one direction (arrow X1 direction) in the first direction (arrow X direction) and is opposed thereto. At the position QC1 (the position coordinate PP is 7.5), the mover magnetic pole 32a is opposed to the center position of the tooth portion 21b. At the position QD1 (the position coordinate PP is 11.25), the mover magnetic pole 32b is displaced in the other direction (arrow X2 direction) in the first direction (arrow X direction) from the center position of the teeth portion 21b and is opposed thereto. As explained, at the positions QA1, QB1, QC1 and QD1, the magnetic pole opposing states thereof are different from one another and accordingly, four different opposing states for the magnetic poles exist.

It is noted here that the respective positions separated from the position QA1 (position coordinate PP is zero) in one direction (arrow X1 direction) of the first direction (arrow X direction) by ¼ slot pitch (¼ sp) of the plurality of (30) slots 21c are respectively defined to be the position QA2, QA3 and QA4. Similarly, the respective positions separated from the position QB1 (position coordinate PP is 3.75) in one direction (arrow X1 direction) of the first direction (arrow X direction) by ¼ slot pitch (¼ sp) of the plurality of (30) slots 21c are respectively defined to be the positions QB2, QB3 and QB4. Similarly, the respective positions separated from the position QC1 (position coordinate PP is 7.5) in one direction (arrow X1 direction) of the first direction (arrow X direction) by ¼ slot pitch (¼ sp) of the plurality of (30) slots 21c are respectively defined to be the position QC2, QC3 and QC4. Further, the respective positions separated from the position QD1 (position coordinate PP is 11.25) in one direction (arrow X1 direction) of the first direction (arrow X direction) by ¼ slot pitch (¼ sp) of the plurality of (30) slots 21c are respectively defined to be the position QD2, QD3 and QD4.

The magnetic pole opposing states of the same kind exist at the positions QA2, QB2, QC2 and QD2, compared to those at the positions QA1, QB1, QC1 and QD1, although the order thereof is different. More specifically, such states are the magnetic pole opposing state opposing to the center position of the slot 21c, the magnetic pole opposing state opposing to the center position of the teeth portion 21b , the magnetic pole opposing state opposing to the center position of the teeth portion 21b at a position shifted from the center position of the teeth portion 21b in one direction (arrow X1 direction) of the first direction (arrow X direction) and the magnetic pole opposing state opposing to the central position of the teeth portion 21b at a position shifted from the center position of the teeth portion 21b in the other direction (arrow X2 direction) of the first direction (arrow X direction). These opposing states can be said to the positions of QA3, QB3, QC3 and QD3 and also can be said to the positions of QA4, QB4, QC4 and QD4.

Further, the positions separated from positions QA4, QB4, QC4 and QD4 in one direction (arrow X1 direction) of the first direction (arrow X direction) by ¼ slot pitch (¼ sp) of the plurality (30) of slots 21c become the same or equivalent magnetic pole opposing states as those of the positions QA1, QB1, QC1 and QD1. Such magnetic pole opposing states repeatedly appear in the first direction (arrow X direction). Accordingly, the attractive force distributions are mixed in the continuously skewed area in the entire third direction (arrow Z direction) by one (1) slot pitch (1 sp) worth of the plurality of (30) slots 21c to thereby average the distribution of the attractive force. Thus, the attractive force distribution at every pole can be equalized.

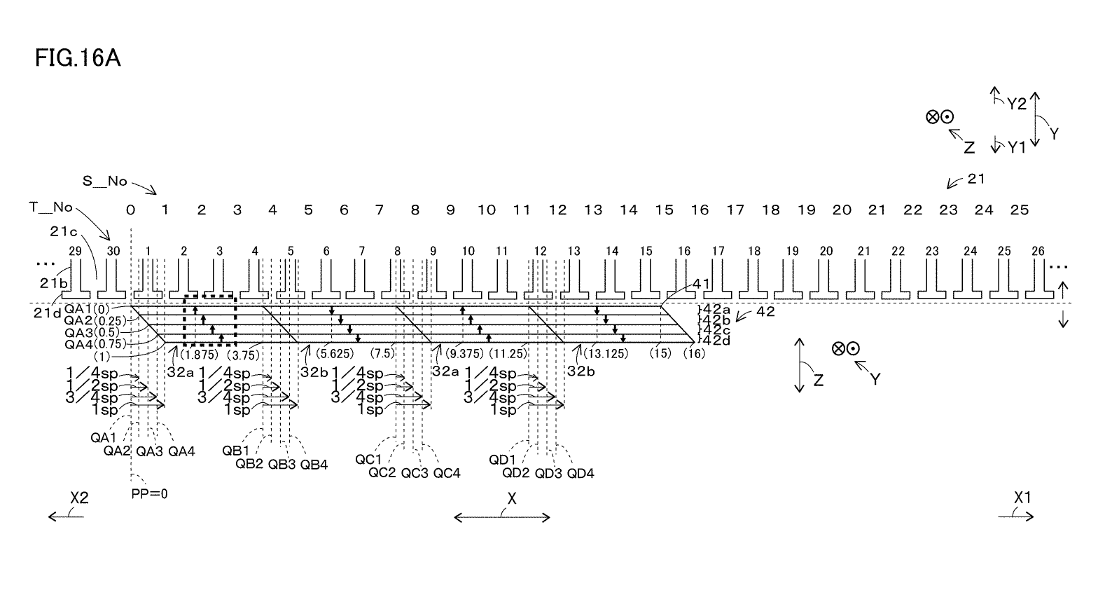

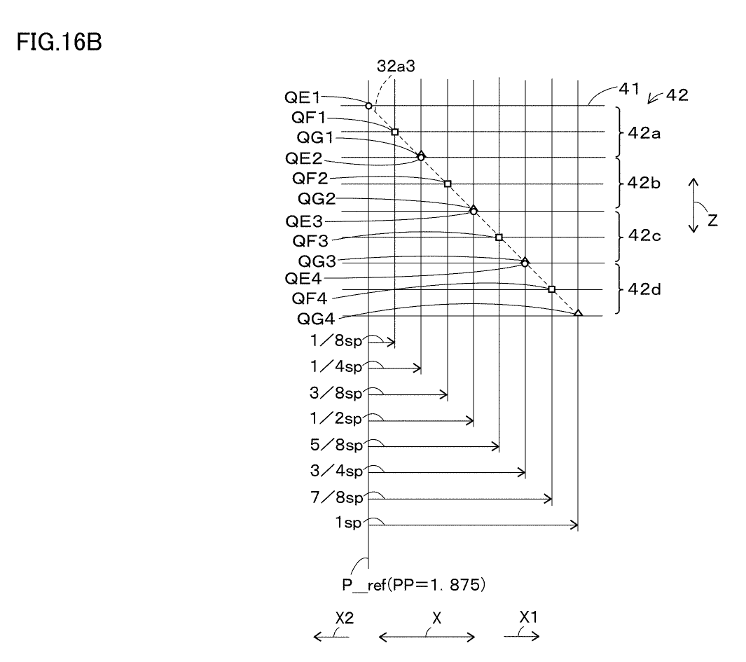

FIG. 16A shows an example of the magnetic pole opposing state between the plurality of teeth portions 21b and the two pairs of mover magnetic poles 32a, 32b according to the embodiment. As shown in the figure, the mover 30 includes the first reference portion 41 and the continuous skew portion 42. Further, the continuous skew portion 42 is gradually shifted in one direction (arrow X1 direction) of the first direction (arrow X direction) relative to the first reference portion 41 and is arranged in the third direction (arrow Z direction). In this embodiment, each part of the continuous skew portion 42, when divided equally into four parts along in the first direction (arrow X direction) on a plane perpendicular to the third direction (arrow Z direction) is referred to as a first continuous skew portion 42a, a second continuous skew portion 42b, a third continuous skew portion 42c and a fourth continuous skew portion 42d in order from the part at the first reference portion 41 side, respectively. As similar to that in the first embodiment, the continuous skew portion 42 is illustrated by separated parts, but the continuous skew portion 42 is integrally formed in one piece.

It is noted here that in the figure, the first reference portion 41 corresponds to one end side end surface of the two pairs of the mover magnetic poles 32a, 32b in the third direction (arrow Z direction). Further, an end surface which is positioned at a different side from the border surface between the third continuous skew portion 42c and the fourth continuous skew portion 42d of the both end surfaces of the fourth continuous skew portion 42d in the third direction (arrow Z direction) corresponds to the other end surface of the two pairs of mover magnetic poles 32a, 32b.

Similarly, in this embodiment, the maximum value of the skew amount of the continuous skew portion 42 relative to the first reference portion 41 is set such that the maximum value of the relative skew amount between the stator 20 and the mover 30 becomes equal to the one slot pitch (1 sp) worth of the plurality (30, in this embodiment) of slots 21c. In this embodiment, the mover 30 is provided with the first reference portion 41 and the continuous skew portion 42, but the stator 20 does not have the first reference portion 41 and the continuous portion 42. Therefore, the skew amount in the stator 20 is zero (0) and the maximum value of the skew amount of the continuous skew portion 42 of the mover 30 relative to the first reference portion 41 becomes one (1) slot pitch (1 sp) worth of the plurality of (30) slots 21c.

As shown in FIG. 16A, the two pairs of mover magnetic poles 32a, 32b on the boundary surface between the first continuous skew portion 42a and the second continuous skew portion 42b are arranged being shifted in one direction (arrow X1 direction) of the first direction (arrow X direction) by ¼ slot pitch (¼ sp) worth relative to the first reference portion 41. The magnetic pole opposing state under this situation becomes equivalent to the magnetic pole opposing state at the positions QA2, QB2, QC2, and QD2. Further, the two pairs of mover magnetic poles 32a, 32b on the boundary surface between the second continuous skew portion 42b and the third continuous skew portion 42c are shifted and arranged in one direction (arrow X1 direction) of the first direction (arrow X direction) by ½ slot pitch (½ sp) worth relative to the first reference portion 41. The magnetic pole opposing state under this situation becomes equivalent to the magnetic pole opposing state at the positions QA3, QB3, QC3, and QD3.

Further, the two pairs of mover magnetic poles 32a, 32b on the boundary surface between the third continuous skew portion 42c and the fourth continuous skew portion 42d are arranged being shifted in one direction (arrow X1 direction) of the first direction (arrow X direction) by ¾ slot pitch (¾ sp) worth relative to the first reference portion 41. The magnetic pole opposing state under this situation becomes equivalent to the magnetic pole opposing state at the positions QA4, QB4, QC4, and QD4. Still further, the other end side end surface of the two pairs of mover magnetic poles 32a, 32b in the third direction (arrow Z direction) is arranged being shifted in one direction (arrow X1 direction) of the first direction (arrow X direction) by one (1) slot pitch (1 sp) worth relative to the first reference portion 41. The magnetic pole opposing state under this situation becomes equivalent to the magnetic pole opposing state at the positions QA1, QB1, QC1, and QD1.

In this embodiment, the magnetic pole opposing state explained above is repeated in the first direction (arrow X direction). Therefore, as similar to that in the first embodiment, the situation that the mixing, the averaging and the equalization of the attractive force distribution at the magnetic pole center position 32a3 of the mover magnetic pole 32a will be considered hereinafter. It is noted that the rotary electric machine 10 of this embodiment is an 8 pole, 30 slot structure rotary electric machine (a rotary electric machine whose basic structure is that the number of magnetic poles of the mover 30 is 4 and the number of slots of the stator 20 is 15). One slot pitch (1 sp) corresponds to an electric angle of 48° (=720°/15 slots).

FIG. 16B is a schematic view showing the magnetic pole opposing state of the area surrounded by the broken line in FIG. 16A. The magnetic pole center position 32a3 (the position coordinate PP is 1.875) of the mover magnetic pole 32a of the first reference portion 41 is defined as a position QE1. Further, the magnetic pole center position 32a3 (the position coordinate PP is 2.125) of the mover magnetic pole 32a at the boundary surface between the first continuous skew portion 42a and the second continuous skew portion 42b is defined as a position QE2. Further, the magnetic pole center position 32a3 (the position coordinate PP is 2.375) of the mover magnetic pole 32a at boundary surface between the second continuous skew portion 42b and the third continuous skew portion 42c is defined as a position QE3. Further, the magnetic pole center position 32a3 (position coordinate PP is 2.625) of the mover magnetic pole 32a at the boundary surface between the third continuous skew portion 42c and the fourth continuous skew portion 42d is defined as the position QE4.

The position QE1 is arranged by being shifted in one direction (arrow X1 direction) of the first direction (arrow X direction) relative to the magnetic pole center position of the teeth portion 21b (the teeth portion 21b having the stator magnetic pole number T_No shown in FIG. 16A is 2). On the other hand, the position QE3 is arranged by being shifted in the other direction (arrow X2 direction) of the first direction (arrow X direction) relative to the magnetic pole center position of the teeth portion 21b (the teeth portion 21b having the stator magnetic pole number T_No shown in FIG. 16A is 3). Therefore, the attractive force distribution formed at the position QE1 and the attractive force distribution formed at the position QE3 are mixed and these attractive force distributions are averaged. As a result, equalization of the attractive force distribution at every pole can be achieved and the component of the space fourth order vibration force increases.

The position QE2 is positioned opposing to the center position of the slot 21c (the center position between the teeth portion 21b having the stator pole number T_No of 2 and the teeth portion 21b having the stator magnetic pole number T_No of 3 shown in FIG. 16A). On the other hand, the position QE4 is positioned opposing to the magnetic pole center position of the teeth portion 21b (the teeth portion 21b having the stator magnetic pole number T_No of 3 shown in FIG. 16A). Therefore, the attractive force distribution formed at the position QE2 and the attractive force distribution formed at the position QE4 are mixed and these attractive force distributions are averaged. As a result, equalization of the attractive force distribution at every pole can be achieved and the component of the space fourth order vibration force increases. When mixing, averaging and equalization of the attractive force distributions are further advanced, the eighth space order component of the vibration force increases. In other words, in comparison with the order decided depending on the number of magnetic poles of the mover 30 (eight poles in this embodiment) (eighth order (space eighth order) in this embodiment), lower order (in this embodiment, second order (space second order)) component of the vibration force is overlapped by shifting half wavelength worth spatially and repeated twice (second order (space second order) →fourth order (space fourth order)→eighth order (space eighth order)). These attractive force distributions are increased to the same level (eighth order (space eighth order) in this embodiment) as the order of the integer slot structure rotary electric machine.

The position QE1 (position coordinate PP is 1.875), the position QE2 (position coordinate PP is 2.125), the position QE3 (position coordinate PP is 2.375) and the position QE4 (position coordinate PP is 2.625) are separated in the first direction (arrow X direction) by 1/c slot pitch (in this embodiment, ¼ slot pitch (¼ sp)) one another. These are referred to as the separated portions. These separated portions explained here may be said to other separated portions separated in the third direction (arrow Z direction).

The circle marks in FIG. 16B indicate separated portions which are indicated by the position QE1 (the position coordinate PP is 1.875), the position QE2 (the position coordinate PP is 2.125), the position QE3 (the position coordinate PP is 2.375) and the position QE4 (position coordinate PP is 2.625). The square marks indicate separated positions which are indicated by the positions QF1 (position coordinate PP is 2), the position QF2 (position coordinate PP is 2.25), the position QF3 (position coordinate PP is 2.5) and the position QF4 (position coordinate PP is 2.75), respectively. The triangle marks indicate separated positions which are indicated by the position QG1 (position coordinate PP is 2.125), the position QG2 (position coordinate PP is 2.375), the position QG3 (position coordinate PP is 2.625) and the position QG4 (position coordinate PP is 2.875), respectively. As shown in the figure, these separated portions are positioned on the broken line indicating the magnetic pole center position 32a3 of the mover magnetic pole 32a. The same can be said to any space between the separated portions, as has been explained regarding to the position QE1 (position coordinate PP is 1.875), the position QE2 (position coordinate PP is 2.125), the position QE3 (position coordinate PP is 2.375), and the position QE4 (position coordinate PP Is 2.625).

Further, the same can be said to any other space between the separated portions other than those illustrated (spaces between the separated portions of the magnetic pole center position 32a3 on the broken line). In other words, over the entire third direction (arrow Z direction), the relationship explained above (relationship between the separated portions which are separated in the first direction (arrow X direction) by ¼ slot pitch (¼ sp)) can be established. Further, the magnetic pole opposing state illustrated in the same figure is repeated in the first direction (arrow X direction) per one slot pitch (1 sp) of the plurality of (30) slots 21c as a unit accompanied by the movement of the mover 30 (movement of the magnetic pole center position 32a3 of the mover magnetic pole 32a by one slot pitch (1 sp) of the plurality of (30) slots 21c).

As explained, by setting the maximum value of the skew amount relative to the first reference portion 41 to be equal to the one slot pitch (1 sp) of the plurality (30) of slots 21c, the attractive force distribution is mixed and averaged over the entire moving direction of the mover 30 in the third direction (arrow Z direction). As a result, the equalization of the attractive force distribution per each pole can be achieved to thereby increase the space eighth order vibration force component. More specifically, in the space between the separated portions (for example, space between circle marks, space between square marks and space between triangle marks), in comparison with the order (eighth order (space eighth order) in this embodiment) decided depending on the number of magnetic poles of the mover 30 (eight poles in this embodiment), lower order (in this embodiment, second order (space second order)) component of the vibration force is overlapped by shifting half wavelength worth to increase the attractive force distributions to the order up to the same level as the integer slot structure rotary electric machine (eighth order (space eighth order) in this embodiment). Therefore, the rotary electric machine 10 of this embodiment can obtain the same operation and effect as those already described in the first embodiment.

Also, as in the first embodiment, the continuous skew portion 42 may be shifted in the other direction (arrow X2 direction) of the first direction (arrow X direction) relative to the first reference portion 41. In this case, the continuous skew portion 42 is gradually shifted in the other direction (arrow X2 direction) of the first direction (arrow X direction) relative to the first reference portion 41 and is arranged in the third direction (arrow Z direction). Further, it is preferable that the increase ratio or the decrease ratio of the skew amount of the continuous skew portion 42 relative to the first reference portion 41 in the third direction (arrow direction Z) from the one end side to the other end side is set constant.

### 1/c Series Rotary Electric Machine 10

In the embodiments explained above, the ½-series rotary electric machine 10 or the ¼ series rotary electric machine 10 is explained as an example. However, the rotary electric machine 10 is not limited to these types and is applicable to any 1/c series rotary electric machine 10.

As explained above, it is noted here that assuming that when the number of slots per every pole and every phase is represented by a mixed fraction, the integer part is defined as an integer portion “a”. Also, assuming that when the true fraction part of the mixed fraction is expressed by irreducible fraction, the numerator part is defined as numerator portion “b” and the denominator part is defined as denominator portion “c”. It is also noted here that the integer portion “a” is assumed to be zero (0) or any positive integer and the numerator portion “b” and the denominator portion “c” are assumed to be any positive integer. Further, in the three-phase rotary electric machine 10, the value of denominator portion “c” is assumed to be two (2) or more, excluding the integer of the values of multiple of three (3). The rotary electric machine 10 is expressed as a “b/c series” rotary electric machine, using the values of the numerator portion “b” and the denominator portion “c”. It is noted here that if the value of the denominator portion “c” is the same, regardless of the value of the numerator portion “b” any type can be applicable,. Accordingly, the b/c series rotary electric machines 10 are collectively referred to as “1/c series” rotary electric machine 10.

In the 1/c series rotary electric machines 10, at least one of the stator 20 and the mover 30 includes the first reference portion 41 and the continuous skew portion 42. Regardless of the value of denominator portion “c”, the maximum value of the skew amount of the continuous skew portion 42 is set such that the maximum value of the relative skew amount between the stator 20 and the mover 30 becomes one slot pitch (1 sp) worth of the plurality of slots 21c.

In the 1/c series rotary electric machines 10, the number “c” kinds of magnetic pole opposing states exist and the attractive force distribution becomes equivalent to each “c” pole of the mover 30. By setting the maximum value of the skew amount of the continuous skew portion 42 such that the maximum value of the relative skew amount between the stator 20 and the mover 30 becomes one slot pitch (1 sp) worth of the plurality of slots 21c, the attractive force distributions formed based on the “c” kinds of the magnetic pole opposing states are mixed over the entire third direction (arrow Z direction) and are averaged. As a result, the attractive force distributions at every pole can be equalized. In more specifically, in a space between the separated portions separated in the first direction (arrow X direction) by 1/c slot pitch, in comparison with the order (2×“p” order (space 2×“p” order)) decided depending on the number of magnetic poles of the mover 30 (2×“p” poles), lower order (2×“p”÷“c” order (space 2×“p”÷“c” order)) component of the vibration force is overlapped by shifting half wavelength worth to increase the attractive force distributions to the order up to the same level as the integer slot structure rotary electric machine (2×“p” order (space 2×“p” order)). Therefore, the 1/c series rotary electric machine 10 can set the number of rotations to be higher to match the specific number of vibrations of the stator iron core 21 to thereby, for example, set the number of rotations beyond the driving number of rotations. In other words, in the 1/c series rotary electric machine 10, a possible resonance of the stator 20 can be avoided and the noise and vibration of the rotary electric machine 10 can be reduced.

Further, the continuous skew portion 42 is gradually shifted in the first direction (arrow X direction) relative to the first reference portion 41 and is arranged in the third direction (arrow Z direction). Further, regardless of the value of denominator portion “c”, the maximum value of the skew amount in the continuous skew portion 42 relative to the reference portion 41 is formed such that the maximum value of the relative skew amount between the stator 20 and the mover 30 becomes equal to one slot pitch (1 sp) worth of the plurality of slots 21c. Therefore, a randomly taken positional portion of the mover 30 in the first direction (arrow X direction) extends in the first direction (arrow X direction) with the width of one slot pitch (1 sp) worth of the plurality of slots 21c to oppose to the stator 20. Thus, the magnetic variation at the opening portion of the slot 21c of the stator 20 gradually occurs and the torque ripple (cogging torque) can be reduced.

### Others

The embodiments of the invention are not limited to those explained above and illustrated in the attached drawings and other modifications and changes can be applicable to the invention a far as such are not deviating from the subject matter of the invention. For example, in the embodiments described above, the mover 30 is provided inside the stator 20 (an inner rotor type rotary electric machine). However, the mover 30 can also be provided outside the stator 20 (outer rotor type rotary electric machine). Further, the rotary electric machine 10 is not limited to a radial gap type or axial gap type rotary electric machine in which the stator 20 and the mover 30 are arranged coaxially. The rotary electric machine 10 can be also adapted to the invention which is a linear type electric motor or a linear type electric generator in which the stator 20 and the mover 30 are disposed on a straight line and the mover 30 moves linearly relative to the stator 20. Furthermore, the rotary electric machine 10 can be used for various fraction slot structure rotary electric machines, for example, used as an electric motor for driving a vehicle, a generator, an electric motor for industrial or home appliance use generator, and the like.

### EXPLANATION OF SYMBOLS AND SIGNS

10: rotary electric machine, 20: stator, 21: stator iron core, 21c: slot, 22: stator coil, 30: mover, 31: mover iron core, 32a, 32b: pair of mover magnetic poles, 41: first reference portion, 41a: third direction one end side first reference portion, 41b: third direction another end side first reference portion, 42: continuous skew portion, 43: second reference portion, 44: step skew portion, 45a : third direction one end side continuous skew portion, 45b: third direction another end side continuous skew portion, 46: center portion, X: first direction, X1: one direction, X2: the other direction, Y: second direction, Z: third direction.

1. A rotary electric machine comprising:
a stator including a stator iron core having a plurality of slots formed therein and a stator coil inserted through the plurality of slots; and
a mover supported on the stator and movable relative to the stator, the mover including a mover iron core and at least one pair of mover magnetic poles provided at the mover iron core, wherein
the rotary electric machine is a fraction slot structure rotary electric machine with the number of slots per every pole and every phase being not an integer, and wherein,
assuming that a moving direction of the mover relative to the stator is defined to be a first direction, an opposing direction in which the stator and the mover oppose to each other is defined to be a second direction and a direction perpendicular to any direction of the first direction and the second direction is defined to be a third direction;
at least one of the stator and the mover includes a first reference portion which is a reference to skew; and
a continuous skew portion arranged in the third direction by being gradually shifted in the first direction relative to the first reference portion, wherein
a maximum value of a skew amount of the continuous skew portion relative to the first reference portion is set such that a maximum value of a relative skew amount between the stator and the mover becomes one slot pitch worth of the plurality of slots.

2. The rotary electric machine according to claim 1, wherein
both the stator and the mover include the first reference portion and the continuous skew portion, and
when the continuous skew portion of one of the stator and the mover is shifted in one direction of the first direction relative to the first reference portion, the continuous skew portion of the other of the stator and the mover is shifted in another direction of the first direction relative to the first reference portion.

3. The rotary electric machine according to claim 2, wherein
the maximum value of the skew amount of the continuous skew portion of the stator and the maximum value of the skew amount of the continuous skew portion of the mover are set to be a same value.

4. The rotary electric machine according to claim 1, wherein
the stator includes the first reference portion and the continuous skew portion;
the mover includes a second reference portion which serves as a reference to skew and a step skew portion arranged in the third direction by being stepwise shifted in the first direction relative to the second reference portion; and wherein
the skew amount of the step skew portion relative to the second reference portion is set to be a half of the maximum value of the skew amount of the continuous skew portion relative to the first reference portion.

5. The rotary electric machine according to claim 4, wherein
when the continuous skew portion of the stator is shifted in one direction of the first direction relative to the first reference portion, the step skew portion of the mover is shifted in another direction of the first direction relative to the second reference portion.

6. The rotary electric machine according to claim 1, wherein an increase ratio or a decrease ratio of the skew amount of the continuous skew portion from one end side to another end side of the third direction relative to the first reference portion is set to be constant.

7. The rotary electric machine according to claim 1, wherein
the mover includes the first reference portion and the continuous skew portion;
the first reference portion includes a third direction one end side first reference portion provided at one end side of the third direction and a third direction another end side first reference portion provided on another end side of the third direction; and wherein
the continuous skew portion includes:
a third direction one end side continuous skew portion in which a half portion of the one end side of the third direction is gradually shifted in one direction of the first direction from the third direction one end side first reference portion and is arranged up to a center portion of the third direction; and
a third direction another end side continuous skew portion in which a half portion of another end side of the third direction is gradually shifted in another direction of the first direction from the center portion and is arranged up to the third direction another end side first reference portion.

8. The rotary electric machine according to claim 7, wherein
an increase ratio of the skew amount of the third direction one end side continuous skew portion relative to the third direction one end side first reference portion is set to be constant from the one end side of the third direction to the center portion thereof;
a decrease ratio of the skew amount of the third direction another end side continuous skew portion relative to the third direction another end side first reference portion is set to be constant from the center portion of the third direction to the another end side thereof; and wherein
an absolute value of the increase ratio and an absolute value of the decrease ratio are set to a same value.
